(19) United States
(12) Patent Application Publication
(10) Pub. No.: US 2019/0055725 A1
(43) Pub. Date: Feb. 21, 2019

(54) CELL FOR STORMWATER MANAGEMENT SYSTEM

(71) Applicant: Pre-Con Products, Simi Valley, CA (US)

(72) Inventor: David Zarraonandia, Thousand Oaks, CA (US)

(21) Appl. No.: 15/680,480

(22) Filed: Aug. 18, 2017

(51) Int. Cl. E03F 1/00; E03F 5/10; B28B 1/14; B28B 11/24; B28B 7/00; B28B 13/06

(52) U.S. Cl. CPC E03F 1/005; E03F 5/101; B28B 13/06; B28B 11/245; B28B 7/0029; B28B 1/14

(57) ABSTRACT

A cell for a stormwater management system includes a body portion, an internal region, and at least one of a top portion or a bottom portion. The body portion includes a plurality of corner columns spaced from each other, a first horizontal member, and a second horizontal member. At least one of the first and second horizontal members is adjacent the at least one of the top portion or the bottom portion and opposite the other horizontal member. The first horizontal member extends between at least two corner columns and has at least a portion curved inward towards the internal region. The second horizontal member extends between at least two corner columns and has at least a portion curved inward towards the internal region. The first and second horizontal members are integrally formed with the body portion.

### CROSS-REFERENCE TO RELATED APPLICATIONS

Not Applicable.

### STATEMENT REGARDING FEDERALLY SPONSORED RESEARCH OR DEVELOPMENT

Not Applicable.

### APPENDIX

Not Applicable

### BACKGROUND

### Field

The present disclosure pertains to a cell for a stormwater management system adapted for retaining or detaining stormwater.

### SUMMARY

One aspect of the present disclosure is a cell for a stormwater management system that includes a body portion, an internal region, and at least one of a top portion or a bottom portion. The body portion includes a plurality of corner columns spaced from each other, a first horizontal member, and a second horizontal member. At least one of the first and second horizontal members is adjacent the at least one of the top portion or the bottom portion and opposite the other horizontal member. The first horizontal member extends between at least two corner columns and has at least a portion curved inward towards the internal region. The second horizontal member extends between at least two corner columns and has at least a portion curved inward towards the internal region. The first and second horizontal members are integrally formed with the body portion.

Another aspect of the present disclosure is a stormwater management system including a first cell and a second cell. The first cell includes a body portion, an internal region, a top portion, and a plate. The body portion includes a plurality of corner columns spaced from each other and extending from the top portion, a first horizontal member, and a second horizontal member. The first horizontal member extends between at least two corner columns and has at least a portion curved inward towards the internal region. The second horizontal member extends between at least two corner columns and has at least a portion curved inward towards the internal region. The plate is coupled, by a plurality of anchors, to the body portion opposite the top portion, and the plate includes a plurality of through holes arranged in a bolt pattern. The second cell includes a body portion, an internal region, a bottom portion, and a plurality of threaded anchors. The body portion includes a plurality of corner columns spaced from each other and extending from the bottom portion, a first horizontal member, and a second horizontal member. The first horizontal member extends between at least two corner columns and has at least a portion curved inward towards the internal region. The second horizontal member extends between at least two corner columns and has at least a portion curved inward towards the internal region. The plurality of threaded anchors are coupled to the body portion opposite the bottom portion. Each of the plurality of threaded anchors are adapted and configured to receive a nut with an outer diameter larger than that of the through holes, and the plurality of threaded anchors are positioned to correspond to the bolt pattern.

Another aspect of the present disclosure is a stormwater management system including a first cell and a second cell. The first cell includes a body portion, an internal region, a top portion, and a gasket. The body portion includes a plurality of corner columns spaced from each other and extending from the top portion, a first horizontal member, and a second horizontal member. The first horizontal member extends between at least two corner columns and has at least a portion curved inward towards the internal region. The second horizontal member extends between at least two corner columns and has at least a portion curved inward towards the internal region. The gasket extends along at least a portion of the perimeter of the top portion. The second cell includes a body portion, an internal region, a top portion, and a gasket. The body portion includes a plurality of corner columns spaced from each other and extending from the bottom portion, a first horizontal member, and a second horizontal member. The first horizontal member extends between at least two corner columns and has at least a portion curved inward towards the internal region. The second horizontal member extends between at least two corner columns and has at least a portion curved inward towards the internal region. The gasket extends along at least a portion of the perimeter of the top portion. The first cell and the second cell are adapted and configured to be placed in the stormwater management system such that a segment of the top portion of the first cell is parallel and adjacent a corresponding segment of the top portion of the second cell. The gasket of the first cell and the gasket of the second cell form a substantially watertight seal between the segment of the top portion of the first cell and the corresponding segment of the top portion of the second cell when the first and second cells are placed in the stormwater management system.

### BRIEF DESCRIPTION OF THE DRAWINGS

FIG. 1 is a perspective view of an embodiment of a stormwater management system of the present disclosure, the stormwater management system having a lower level of cells, an upper level of cells, and an intermediate level of cells.

FIG. 2 is a side elevational view of the stormwater management system of FIG. 1.

FIG. 3 is a perspective view of the stormwater management system of FIG. 1 with portions broken away to show detail.

FIG. 4 is a cross-sectional view taken along the plane of line 4-4 of FIG. 2.

FIG. 5 is a perspective view of one of the cells of the upper level of cells of the stormwater management system of FIG. 1.

FIG. 6 is a perspective view of one of the cells of the intermediate level of cells of the stormwater management system of FIG. 1.

FIG. 7 is a perspective view of one of the cells of the lower level of cells of the stormwater management system of FIG. 1.

FIG. 8 is a perspective view of another embodiment of a cell of the present disclosure, the cell of FIG. 8 being similar to the cell of FIG. 5 but having a flat top portion.

FIG. 9 is a perspective view of another embodiment of a cell of the present disclosure, the cell of FIG. 9 being similar to the cell of FIG. 7 but having a closed bottom portion.

FIG. 10 is a perspective view of another embodiment of a stormwater management system of the present disclosure.

FIG. 11 is a perspective view of the stormwater management system of FIG. 10 with portions broken away to show detail.

FIG. 12 is a perspective view of another embodiment of a stormwater management system of the present disclosure, the stormwater management system having an upper level of cells and a lower level of cells.

FIG. 13 is a perspective view of a cell of the upper level of cells and a cell of the lower level of cells of the stormwater management system of FIG. 12.

FIG. 14a is a perspective view of an alternative embodiment of a cell of the upper level of cells and an alternative embodiment of a cell of the lower level of cells of the stormwater management system of FIG. 12.

FIG. 14b is an elevational view of the upper cell and the lower cell shown in FIG. 14a.

FIG. 15 is a perspective view of inner and outer mold components with portions broken away to show detail.

FIG. 16 is a top plan view of the inner and outer mold components of FIG. 15, walls of the outer mold component being shown in a latched configuration in solid lines and an unlatched configuration in dashed lines.

FIG. 17 is a perspective view of an alternative embodiment of a cell of the upper level of cells and an alternative embodiment of a cell of the lower level of cells for use in a stormwater management system such as that depicted in FIG. 12.

FIG. 18 is side view of the upper level cell depicted in FIG. 17.

FIG. 19 is a perspective view of the upper level cell depicted in FIGS. 17 and 18.

FIG. 20 is a partial exploded and perspective view of a stormwater management system having an upper level and lower level of cells.

FIG. 21 is a perspective view of an upper level corner cell for use in a stormwater management system such as that depicted in FIG. 20.

FIG. 22 is a further perspective view of the upper level corner cell depicted in FIG. 21.

FIG. 23 is a perspective view of a lower level corner cell for use in a stormwater management system such as that depicted in FIG. 20.

FIG. 24 is a perspective view of an upper level interior cell and a lower level interior cell for use in a stormwater management system such as that depicted in FIG. 20.

FIG. 25 is a perspective view of the upper level interior cell depicted in FIG. 24.

FIG. 26 is a perspective view of the lower level interior cell depicted in FIG. 24.

FIG. 27 is a side view of an alternative cell for use in a stormwater management system.

FIG. 28 is a top view of the cell depicted in FIG. 27.

FIG. 29 is a perspective view of a stormwater management system having a single level of cells.

FIG. 30 is a perspective view of an alternative stormwater management system having a single level of cells.

FIG. 31 is a side view of an upper level cell and a lower level cell coupled together by fastener system.

FIG. 32 is a partial detail view of the fastener system depicted in FIG. 31.

FIG. 33 is a partial view of a stormwater management system including a plurality of gaskets.

FIG. 34 is a side view of the stormwater management system depicted in FIG. 33.

FIG. 35 is detail view of a portion of the stormwater management system depicted in FIG. 34.

Reference numerals in the written specification and in the drawing figures indicate corresponding items.

### DETAILED DESCRIPTION OF THE PREFERRED

U.S. patent application Ser. No. 15/043,032, filed Feb. 12, 2016, and U.S. patent application Ser. No. 14/710,230, filed on May 12, 2015, are both incorporated herein in their entireties.

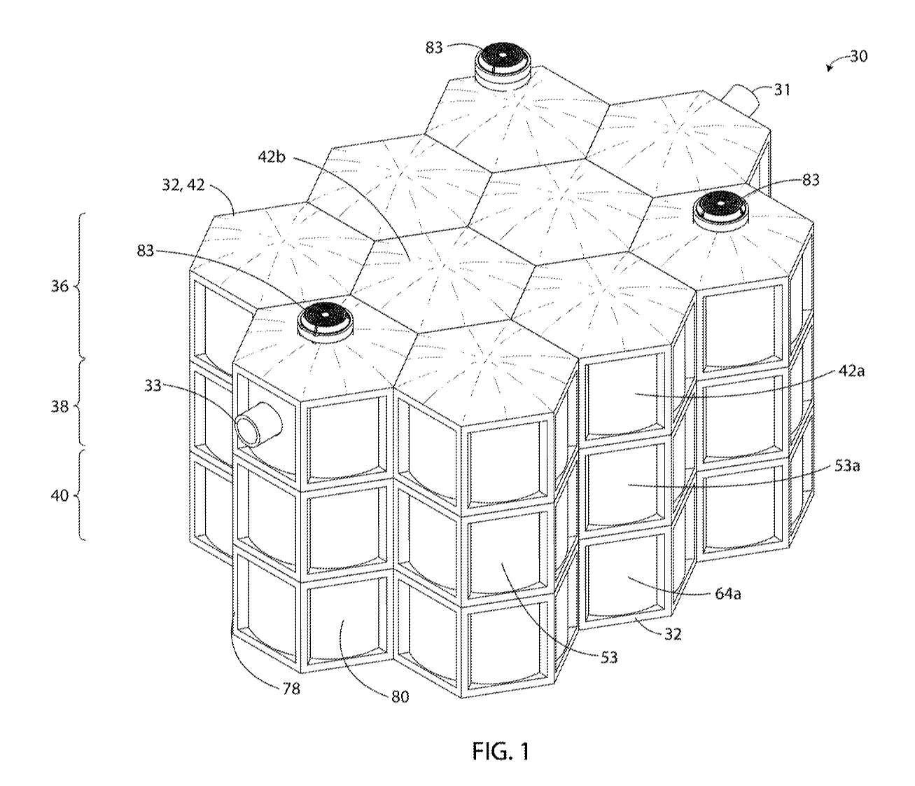

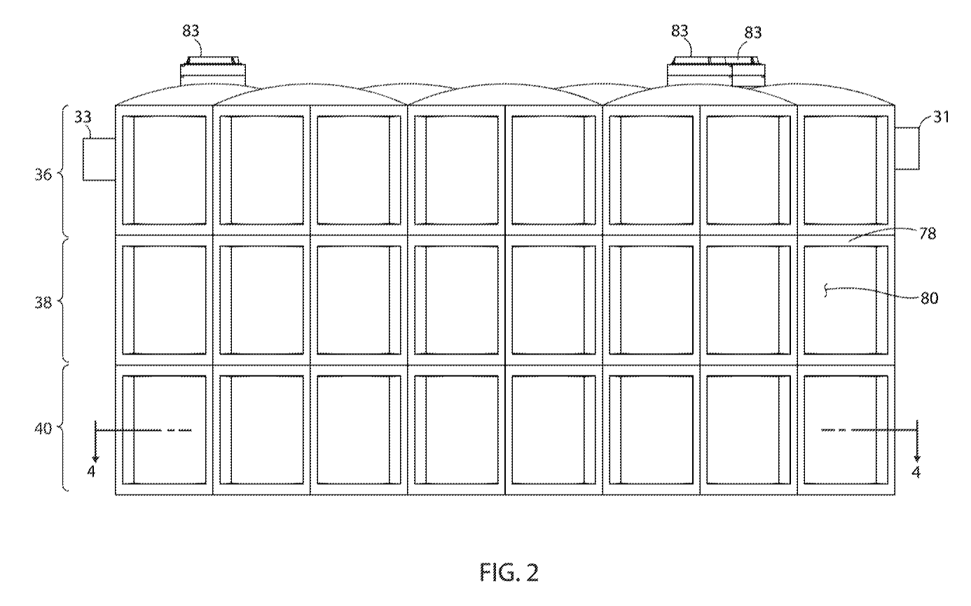

An embodiment of a stormwater management system is shown in FIGS. 1-4 and indicated generally by reference numeral 30. The stormwater management system 30 is adapted for retaining or detaining stormwater. The stormwater management system 30 comprises an inlet 31 and an outlet 33. The inlet 31 is adapted to enable stormwater to enter the stormwater management system 30 and the outlet 33 is adapted to enable stormwater to be removed from the stormwater management system. One of ordinary skill in the art will understand that the location of the inlet and the location of the outlet could be different from that shown in FIGS. 1 and 2. Moreover, one of ordinary skill in the art will understand that the stormwater management system could comprise additional inlets and/or outlets.

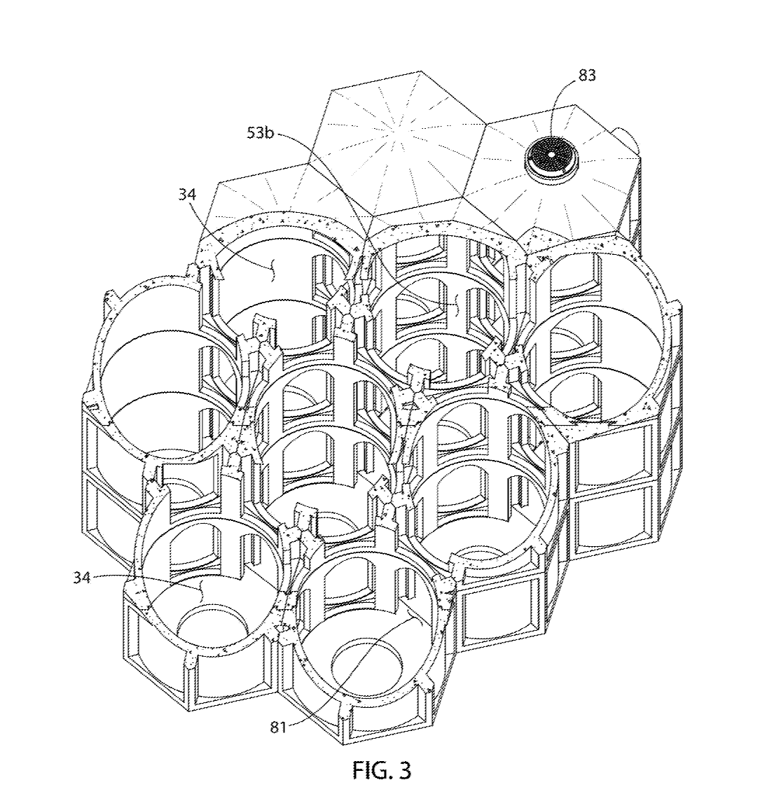

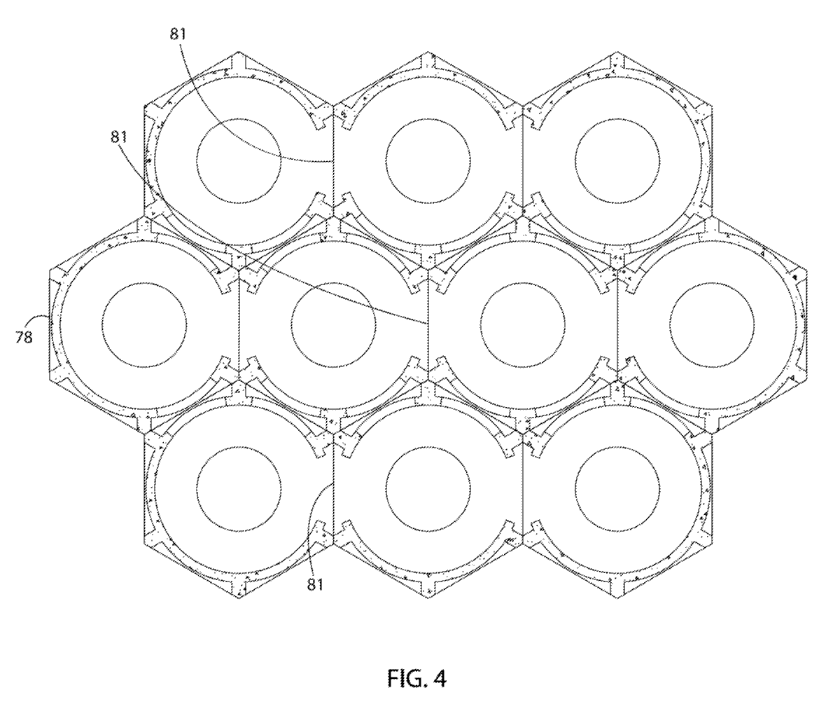

The stormwater management system 30 comprises a plurality of cells 32. Each cell 32 is made from a material suitable for use within a stormwater management system, including, but not limited to, concrete. The plurality of cells 32 are arranged in a generally honeycomb configuration. As can be seen in FIGS. 3 and 4, each of the plurality of cells 32 is generally hexagonal in cross-section and has an internal region 34. Moreover, each cell within the stormwater management system 30 is a module (i.e., of a unitary, one piece construction). It is to be understood, however, that the stormwater management system 30 could be constructed such that each cell (or alternatively, each of some of the cells) is made of separate pieces that collectively fit together to form a cell. The plurality of cells 32 are in fluid communication with one another to allow stormwater to flow from the internal region of one of the plurality of cells to the internal region of another of the plurality of cells.

As shown in FIGS. 1 and 2, the plurality of cells 32 comprises an upper level of cells 36, an intermediate level of cells 38, and a lower level of cells 40. The upper level of cells 36 is over the intermediate level of cells 38. Additionally, the upper level of cells 36 is in fluid communication with the intermediate level of cells 38. The intermediate level of cells 38 is over the lower level of cells 40. Additionally, the intermediate level of cells 38 is in fluid communication with the lower level of cells 40. Accordingly, the upper level of cells 36 is in fluid communication with the lower level of cells 40 via the intermediate level of cells 38.

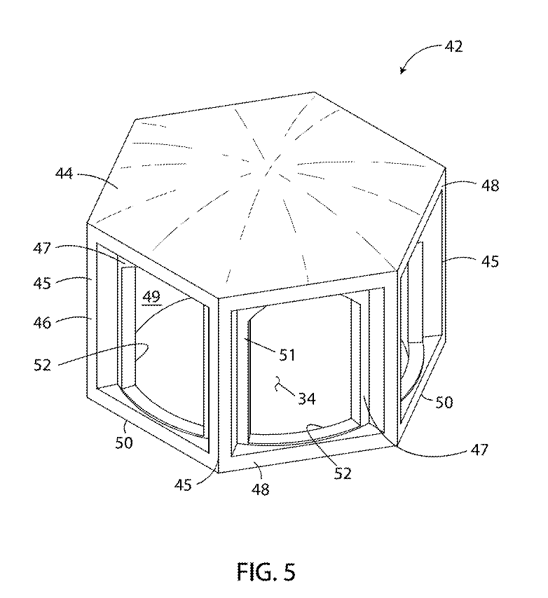

An exemplary cell 42 located within the upper level of cells 36 is shown in FIG. 5. Cell 42 comprises a top portion 44 and a body portion 46. The top portion 44 and the body portion 46 bound the internal region 34 of cell 42. The top portion 44 and the body portion 46 are generally hexagonal in cross-section. Although the cell 42 of the present embodiment is a module of a molded, one-piece construction, it is to be understood that the top portion 44 and the body portion 46 could be separate pieces that fit together to collectively form cell 42. The top portion 44 of cell 42 is domed such that an inner surface (not shown) of the top portion is concave. It is to be understood that the top portion 44 of cell 42 could alternatively be substantially flat. The body portion 46 includes six corner columns 45 spaced from each other, six sides 48, and a plurality of windows 52. Each side 48 comprises a wall portion 47. Each wall portion 47 extends from one of the corner columns 45 to another of the corner columns. Each wall portion 47 comprises an inner surface 49 and an outer surface 51. The inner surface 49 and the outer surface 51 of each wall portion 47 is curved. More specifically, the inner surface 49 and the outer surface 51 of each wall portion 47 is arcuate. The inner surfaces 49 of the plurality of wall portions 47 collectively constitute an interior surface. The interior surface is of a shape that is generally a right circular cylinder. The interior surface at least partially surrounds the internal region 34 of the cell 42. The body portion 46 further comprises a bottom edge 50. The body portion 46 is generally in the shape of a hexagonal cylinder. More specifically, the body portion 46 is generally in the shape of an equilateral hexagonal cylinder. Each window 52 is in a different one of the six sides 48 and through a wall portion 47. Additionally, each window is spaced from the top portion 44 and the bottom edge 50. Additionally, each window 52 is adapted to permit the passage of stormwater into and out of the internal region 34 of cell 42. Although FIG. 5 shows that each window 52 is of the same arched dimension, it is to be understood that the windows could be of different dimensions. Preferably, each window is dimensioned such that an area of each window is at least 50% of an area of the side of the cell in which each window is located. More preferably, each window is dimensioned such that an area of each window is at least 60% of an area of the side in which each window is located. It is also to be understood that a cell could have more or fewer windows than that of cell 42. For example, cell 42a has four windows and cell 42b has six windows (see FIG. 1).

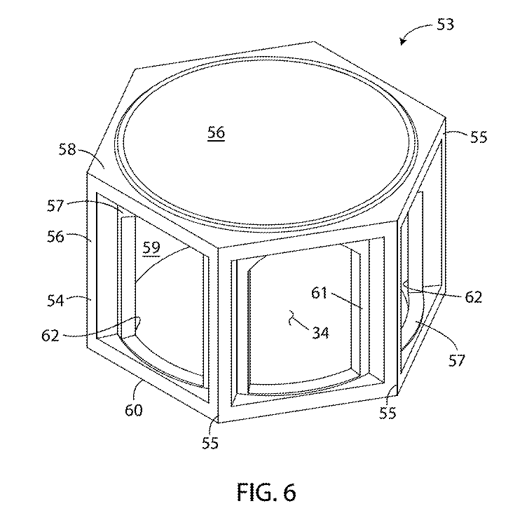

An exemplary cell 53 located within the intermediate level of cells 38 is shown in FIG. 6. Cell 53 comprises a body portion 54 having six corner columns 55, six sides 56, a top edge 58, a bottom edge 60, and a plurality of windows 62. The body portion 54 bounds the internal region 34 of cell 53. Each side 56 comprises a wall portion 57. Each wall portion 57 extends from one of the corner columns 55 to another of the corner columns. Each wall portion 57 comprises an inner surface 59 and an outer surface 61. The inner surface 59 and the outer surface 61 of each wall portion 57 is curved. More specifically, the inner surface 59 and the outer surface 61 of each wall portion 57 is arcuate. The inner surface 59 of the plurality of wall portions 57 collectively constitute an interior surface. The interior surface is of a shape that is generally a right circular cylinder. The interior surface at least partially surrounds the internal region 34 of the cell 53. The body portion 54 is generally in the shape of a hexagonal cylinder. More specifically, the body portion 54 is generally in the shape of an equilateral hexagonal cylinder. Each window 62 is in a different one of the six sides 56 and through a wall portion 57. Additionally, each window 62 is spaced from the top and bottom edges 58, 60 of the body portion 54. Additionally, each window 62 is adapted to permit the passage of stormwater into and out of the internal region 34 of cell 53. Although FIG. 6 shows that each window 62 is of the same arched dimension, it is to be understood that the windows could be of different dimensions. It is also to be understood that a cell could have more or fewer windows that that of cell 53. For example, cell 53a in FIG. 1 has four windows and cell 53b in FIG. 3 has six windows.

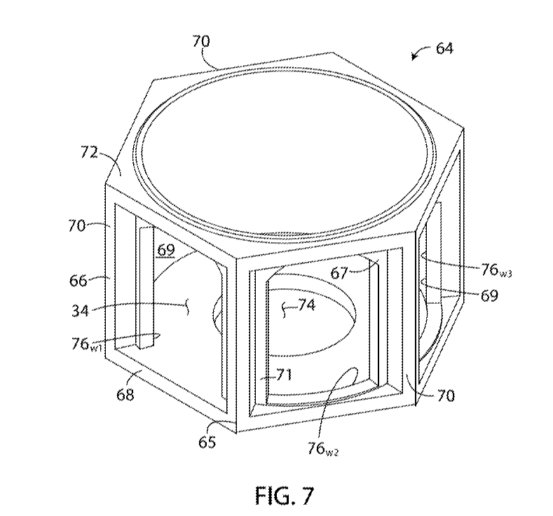

An embodiment of an individual cell 64 located within the lower level of cells 40 is shown in FIG. 7. Cell 64 comprises a body portion 66 and a bottom portion 68 that are generally hexagonal in cross-section. The body portion 66 and the bottom portion 68 bound the internal region 34 of cell 64. The body portion 66 includes six corner columns 65 spaced from each other, six sides 70, a top edge 72, and a plurality of windows 76. Each side 70 comprises a wall portion 67. Each wall portion 67 extends from one of the corner columns 65 to another of the corner columns. Each wall portion 67 comprises an inner surface 69 and an outer surface 71. The inner surface 69 and the outer surface 71 of each wall portion 67 is curved. More specifically, the inner surface 69 and the outer surface 71 of each wall portion 67 is arcuate. The inner surfaces 69 of the plurality of wall portions 67 collectively constitute an interior surface. The interior surface is of a shape that is generally a right circular cylinder. The interior surface at least partially surrounds the internal region 34 of cell 64. Although the cell 64 of the present embodiment is a module, it is to be understood that the bottom portion 68 and the body portion 66 could be separate pieces that fit together to collectively form cell 64. The body portion 66 is generally in the shape of a hexagonal cylinder. More specifically, the body portion 66 is generally in the shape of an equilateral hexagonal cylinder. The bottom portion 68 of cell 64 is substantially flat and constitutes a floor for the cell. The bottom portion 68 has an opening 74 that is adapted such that stormwater can pass therethrough and flow out of the internal region 34 of cell 64. Cell 64 has a first window 76_{W1}, a second window 76_{W2}, and a third window 76_{W3}. As shown in FIG. 7, each window 76 is in a different one of the six sides 70 and through a wall portion 67. The first window 76_{W1} is spaced from the top edge 72. The second and third windows 76_{W2}, 76_{W3} are spaced from the top edge 72 and the bottom portion 68. Each window 76 is adapted to permit passage of stormwater into and out of the internal region 34 of cell 64. Although FIG. 7 shows that each window 76 is of the same arched dimension, it is to be understood that the windows could be of different dimensions. It is to be understood that a cell could have more or fewer windows than that of cell 64. For example, cell 64a in FIG. 1 contains four windows.

As can be seen in FIG. 3, a body portion of each of the plurality of cells 32 within the stormwater management system 30 is substantially the same size as the body portion of the other cells within the stormwater management system. It is to be understood, however, that the body portion of at least some of the cells could be of a different size. Moreover, as can be seen in FIGS. 1-3, the plurality of cells 32 within the stormwater management system 30 are arranged in a manner such that the plurality of cells constitute a network having an outer periphery 78. Some of the sides of the plurality of cells 32 located along an outer edge of the stormwater management system 30 constitute the outer periphery 78. The cells 32 of the stormwater management system 30 are preferably arranged such that the outer periphery 78 does not contain any windows. Each side constituting the outer periphery 78 of the stormwater management system 30 preferably comprises a wall portion 80 that is curved. It is to be understood, however, that some or all of the sides that constitute the outer periphery 78 of the stormwater management system 30 could be substantially flat.

As shown in FIGS. 3 and 4, the lower level of cells 40 of the stormwater management system 30 are arranged in a manner so as to form a plurality of parallel walkways 81. Each walkway 81 extends in a single direction from a first side of the stormwater management system to an opposite side of the stormwater management system. Each walkway 81 enables a user to pass from the internal region 34 of one cell within the lower level of cells 40 to the internal region of another cell within the lower level of cells 40 without having to step over a raised surface. A user is able to gain access to the underground system 30 via a plurality of port holes 83 located within the upper level of cells 36.

The stormwater management system 30 is formed by arranging the lower level of cells 40, the intermediate level of cells 38, and the upper level of cells 36 in a generally honeycomb configuration. The intermediate level of cells 38 is arranged between the lower level of cells 40 and the upper level of cells 36. The upper level of cells 36 is arranged such that each one of the top portions 44 is in contact with the top portion 44 of another cell. Some of the upper level of cells 36 are arranged such that the top portions 44 of the cells are in contact with the top portions 44 of at least two other cells.

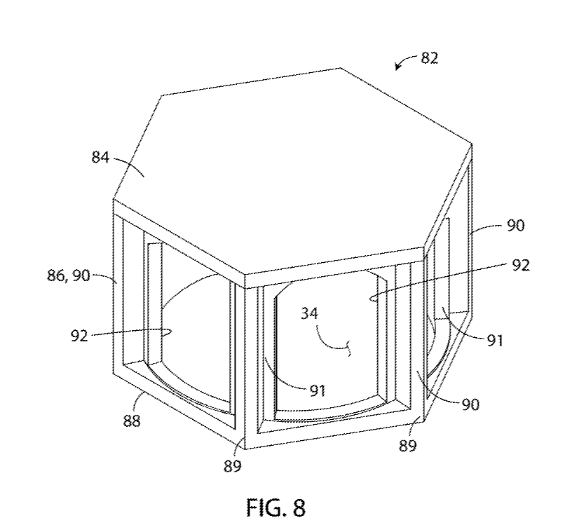

Another embodiment of an individual cell 82 that could be located within the upper level of cells 36 is shown in FIG. 8. Cell 82 comprises a top portion 84, a body portion 86, and a bottom edge 88. The top portion 84 and the body portion 86 bound the internal region 34 of cell 82. Each of the top portion 84 and the body portion 86 is substantially hexagonal in cross-section. The top portion 84 of cell 82 is substantially flat. It is to be understood, however, that the top portion 84 of the cell 82 can be domed. Each of the body portion 86 and the top portion 84 are separate pieces that fit together to collectively form cell 82. The body portion 86 comprises six corner columns 89, six sides 90, and plurality of windows 92. Each side 90 comprises a wall portion 91. Each wall portion 91 extends from one of the corner columns 89 to another of the corner columns. Each window 92 is in a different one of the six sides 90 and through a wall portion 91. Each window is adapted to permit passage of stormwater into and out of the internal region 34 of cell 82. Although FIG. 8 shows that each window 92 is of the same arched dimension, it is to be understood that the windows could be of different dimensions. It is also to be understood a cell could have more or fewer windows than that of cell 82.

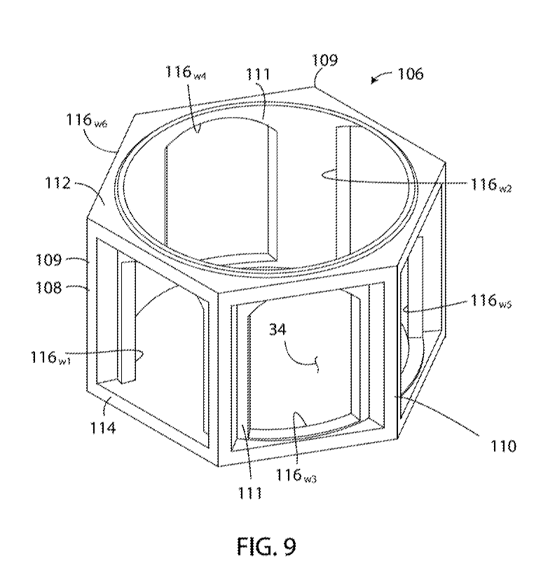

An alternative embodiment of an individual cell 106 that could be located within the lower level of cells 40 is shown in FIG. 9. Cell 106 comprises a body portion 108 having six corner columns 109, six sides 110, a top edge 112, a bottom portion 114, and a plurality of windows 116. Each side 110 comprises a wall portion 111. Each wall portion 111 extends from one of the corner columns 109 to another of the corner columns. The body portion 108 comprises a first window 116_{W1}, a second window 116_{W2}, a third window 116_{W3}, a forth window 116_{W4}, a fifth window 116_{W5}, and a sixth window 116_{W6}. As shown in FIG. 9, each window is in a different one of the six sides 110 and through a wall portion 111. The first and second windows 116_{W1}, 116_{W2} are opposite each other, the third and fourth windows 116_{W3}, 116_{W4} are opposite each other, and the fifth and six windows 116_{W5}, 116_{W6} are opposite each other. The first and second windows 116_{W1}, 116_{W2} are spaced from the top edge 112 of the body portion 108. The first and second windows 116_{W1}, 116_{W2} are not spaced from the bottom portion 114. The third, fourth, fifth, and sixth windows 104_{W3}, 104_{W4}, 104_{W5}, 104_{W6} are spaced from the top edge 112 and bottom portion 114. The bottom portion 114 constitutes a floor for cell 106. Although FIG. 9 shows that each window is of the same arched dimension, it is to be understood the windows could be of different dimensions. It is also to be understood that a cell could have more or fewer windows than that of cell 106.

One of ordinary skill in the art will appreciate that the upper level of cells 36 within the stormwater management system 30 could be assembled of cells consistent with cell embodiment 42, cells consistent with cell embodiment 82, or cells consistent with cell embodiments 42 and 82. Similarly, one of ordinary skill in the art will appreciate that the lower level of cells 40 could be assembled of cells consistent with cell embodiment 64, cells consistent with cell embodiment 106, or cells consistent with cell embodiments of 64 and 106.

One of ordinary skill in the art will also appreciate that the stormwater management system 30 can be formed such that the intermediate level of cells 38 is omitted. Alternatively, one of ordinary skill in the art will appreciate that the stormwater management system 30 can be formed such that the stormwater management system includes more than one intermediate level of cells.

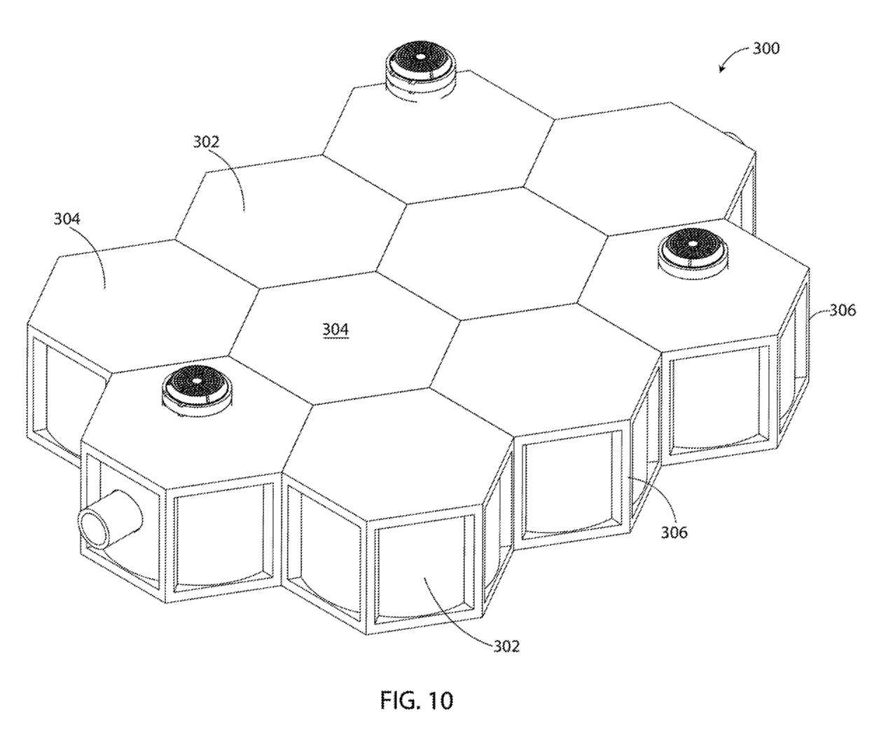

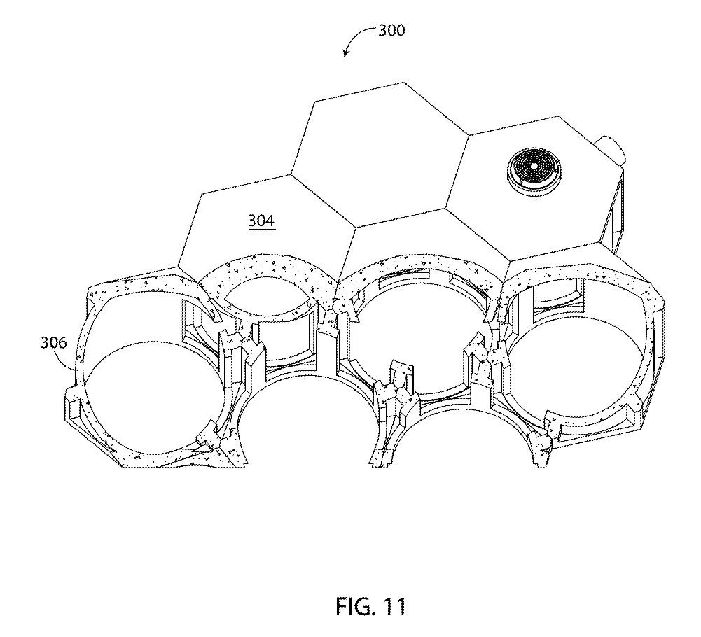

Another embodiment of a stormwater management system is shown in FIGS. 10 and 11 and indicated generally by reference numeral 300. The underground system 300 is similar to the stormwater management system 30, except that it comprises only a single level of cells 302 wherein each cell is generally level with each other cell. Although FIGS. 10-11 depicts each of the plurality of cells 302 within the stormwater management system 300 as having a substantially flat top portion 304, one of ordinary skill in the art will understand that the top portion of each of the plurality of cells could be domed. Moreover, as shown in FIG. 11, each of the plurality of cells 302 comprises only a top portion 304 and a body portion 306. Notably, each of the plurality of cells does not comprise a bottom portion. One of ordinary skill in the art, however, will understand that all or some of the plurality of cells 302 could comprise a bottom portion. One of ordinary skill in the art will also understand that if all or some the plurality of cells 302 contain a bottom portion, the bottom portion may have an opening to enable stormwater to pass therethrough.

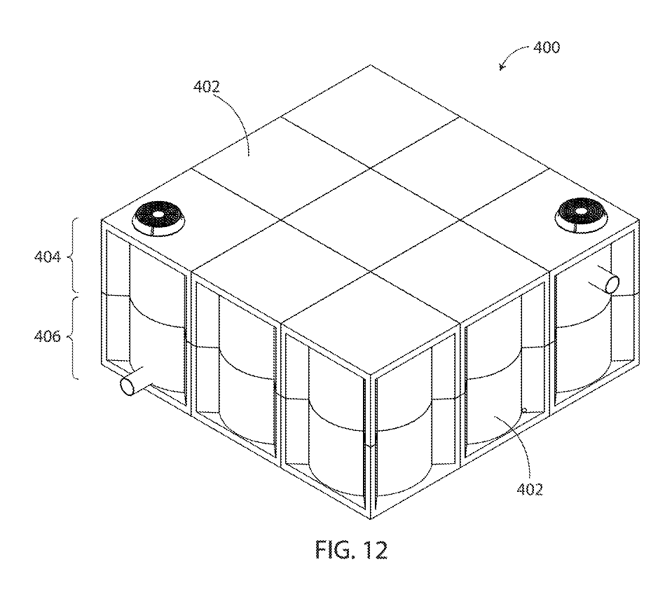

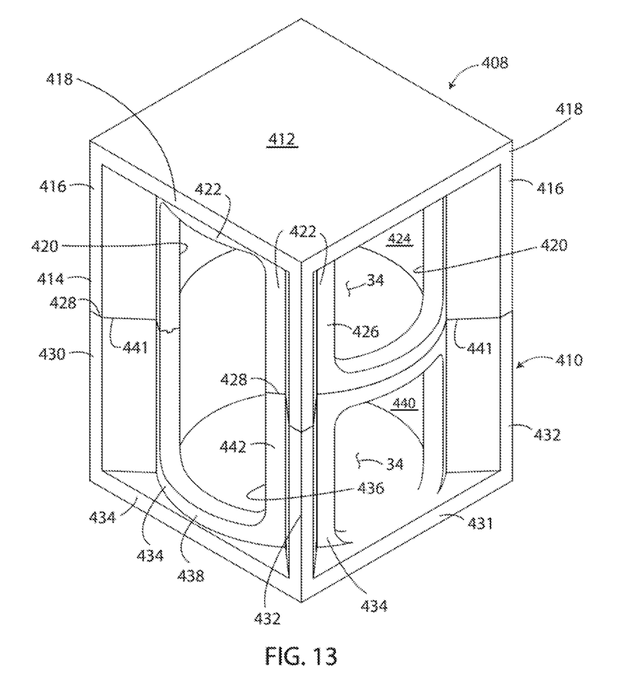

Another embodiment of a stormwater management system is shown in FIGS. 12 and 13 and indicated generally by reference numeral 400. The underground system 400 is similar to the stormwater management system 30. The underground system 400 comprises a plurality of cells 402. The plurality of cells 402 comprises an upper level of cells 404 and a lower level of cells 406. The upper level of cells 404 is in fluid communication with the lower level of cells 406.

An exemplary cell 408 located within the upper level of cells 404 is shown in FIG. 13. Cell 408 comprises a top portion 412 and body portion 414. The body portion 414 comprises four corner columns 416 spaced from each other, four sides 418, and a plurality of windows 420. Each side 418 comprises a wall portion 422. Each wall portion 422 comprises an inner surface 424 and an outer surface 426. The inner surface 424 and the outer surface 426 of each wall portion 422 is curved. More specifically, the inner surface 424 and the outer surface 426 of each wall portion 422 is arcuate. The inner surfaces 424 of the plurality of wall portions 422 collectively constitute an interior surface. The interior surface is of a shape that is generally a right circular cylinder. The interior surface at least partially surrounds the internal region 34 of cell 408. The body portion further comprises a bottom edge 428. Each window 420 is in a different one of the four sides 418 and through a wall portion 422. Each window 420 is spaced from the top portion 412. As seen in FIG. 13, each window may, but is not required to be, spaced from the bottom edge 428 as well.

An exemplary cell 410 located within the lower level of cells 406 is also shown in FIG. 13. Cell 410 comprises a body portion 430 and a bottom portion 431. The body portion 430 comprises four corner columns 432 spaced from each other, four sides 434, and a plurality of windows 436. Each side 434 comprises a wall portion 438. Each wall portion 438 comprises an inner surface 440 and an outer surface 442. The inner surface 440 and the outer surface 442 of each wall portion 438 is curved. More specifically, the inner surface 440 and the outer surface 442 of each wall portion 438 is arcuate. The inner surfaces 440 of the plurality of wall portions 438 collectively constitute an interior surface. The interior surface is of a shape that is generally a right circular cylinder. The interior surface at least partially surrounds the internal region 34 of cell 410. The body portion further comprises a top edge 441. Each window 436 is in a different one of the four sides 434 and through a wall portion 438. At least one window 436 is spaced from the bottom portion 431. As seen in FIG. 13, each window 436 may, but is not required to be, spaced from the top edge 441 as well.

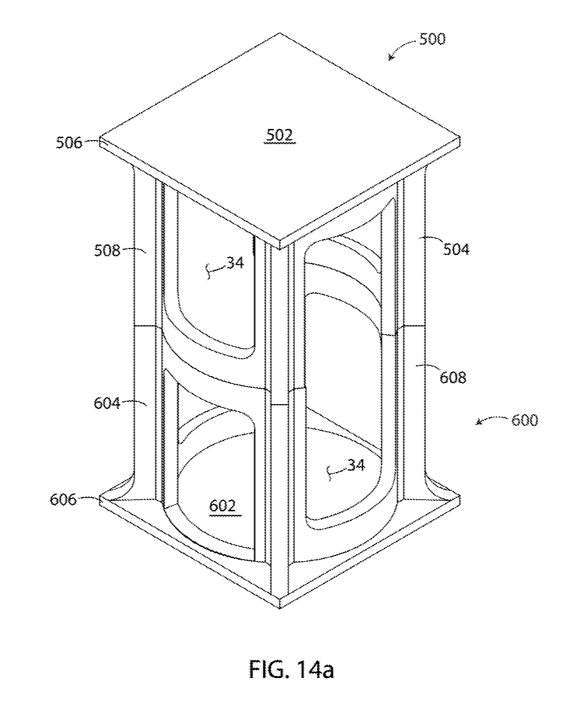

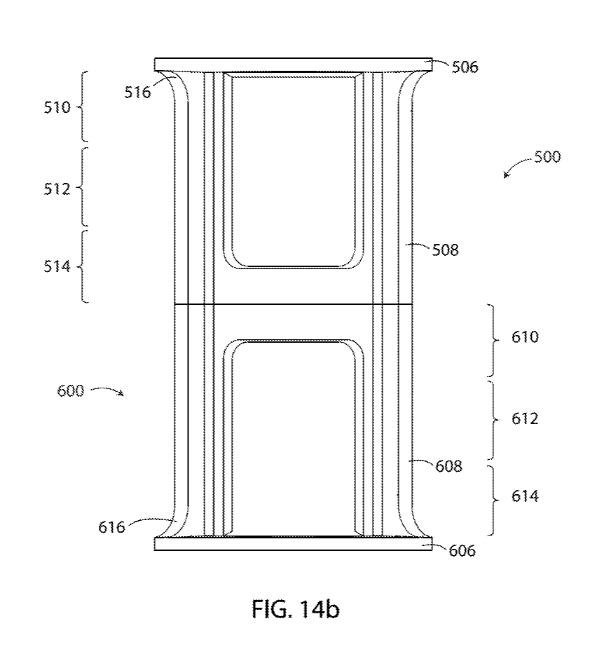

Another embodiment of a cell 500 capable of being located within the upper level of cells 404 is shown in FIGS. 14a and 14b. Cell 500 is similar to cell 408. Cell 500 comprises a top portion 502 and a body portion 504. The top portion 502 has an outermost edge surface 506. The body portion 504 comprises four corner columns 508 spaced from each other. Each corner column 508 comprises a top region 510, an intermediate region 512, and an bottom region 514. The intermediate region 512 extends from the top region 510 to the bottom region 514. Each corner column 508 of cell 500 is shaped such that the bottom region 514 and the intermediate region 512 of each corner column are spaced inwardly from the outermost edge surface 506 of the top portion 502. The top region 510 of each corner column 508 is curved or shaped such that a portion of the top region (e.g., tapered portion 516) extends to the outermost edge surface 506. Because the bottom region 514 and the intermediate region 512 of each corner column 508 are spaced inwardly from the outermost edge surface 506 of the top portion 502, stormwater is capable of flowing around each of the corner columns to an adjacent cell without passing through the internal region 34 of cell 500. It is to be understood that in an alternative embodiment of cell 500, the bottom region 514 and the intermediate region 512 of less than all of the corner columns 508 could be spaced inwardly from the outermost edge surface 506 such that stormwater is capable of flowing around some (but not all) of the corner columns 508 without passing through the internal region 34 of the cell. It is also to be understood that in an alternative embodiment of cell 500, the top region 510, the bottom region 514, and the intermediate region 512 of each (or some) of the corner columns 508 could be spaced inwardly from the outermost edge surface 506 of the top portion 502.

Another embodiment of a cell 600 capable of being located within the lower level of cells 406 is also shown in FIGS. 14a and 14b. Cell 600 is similar to cell 410. Cell 600 comprises a bottom portion 602 and a body portion 604. The bottom portion 602 has an outermost edge surface 606. The body portion 604 comprises four corner columns 608 spaced from each other. Each corner column 608 comprises a top region 610, a bottom region 614, and an intermediate region 612. The intermediate region 612 extends from the top region 610 to the bottom region 614. Each corner column 608 of cell 600 is shaped such that top region 610 and the intermediate region 612 of each corner column is spaced inwardly from the outermost edge surface 606 of the bottom portion 602. The bottom region 614 of each corner column 608 is curved or otherwise shaped such that a portion of the bottom region (e.g., tapered portion 616) extends to the outermost edge surface 606. Because the top region 610 and the intermediate region 612 of each corner column 608 are spaced inwardly from the outermost edge surface 606 of the bottom portion 602, stormwater is capable of flowing around each of the corner columns to an adjacent cell without passing through the internal region 34 of cell 600. Depending upon the arrangement of the cells and the types of cells used within a lower level of a stormwater management system, the capability of stormwater to flow around some or all of the corner columns of a cell without passing through an internal region of said cell could prevent a damming or pooling effect in the stormwater management system. It is to be understood that in an alternative embodiment of cell 600, the top region 610 and the intermediate region 612 of less than all of the corner columns 608 could be spaced inwardly from the outermost edge surface 606 such that stormwater is capable of flowing around some of the corner columns without passing through the internal region 34 of the cell. It is also to be understood that in an alternative embodiment of cell 600, the top region 610, the bottom region 614, and the intermediate region 612 of each (or some) of the corner columns 508 could be spaced inwardly from the outermost edge surface 606 of the bottom portion 602.

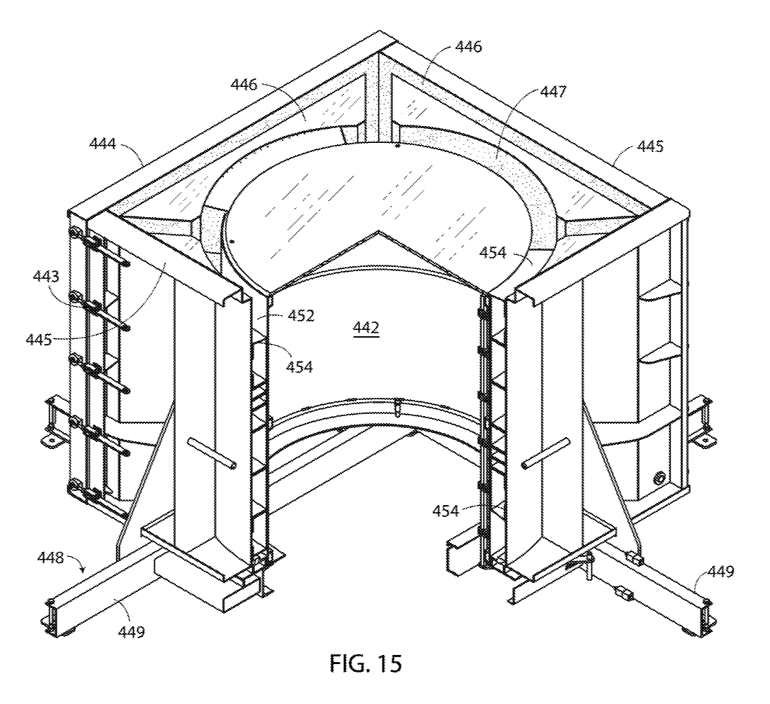

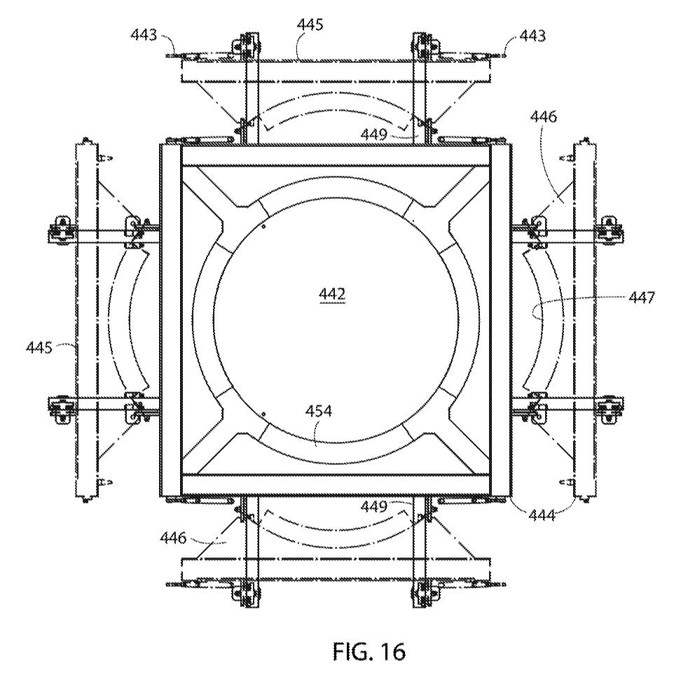

A method of manufacturing a stormwater management module comprises positioning an inner mold component 442 and an outer mold component 444 relative to each other such that the inner mold component is within the outer mold component. As seen in FIGS. 15 and 16, the outer mold component 444 comprises at three mold surfaces 446. Depending upon the module being manufactured and the module's intended shape, the outer mold component 444 can comprise either more or fewer mold surfaces. In FIGS. 15 and 16, the outer mold component 444 comprises a plurality of walls 445, each wall comprising a plurality of mold surfaces 446. The walls 445 are capable of being connected to each other via a plurality of latches 443. FIG. 16 shows the walls 445 in a latched configuration in sold lines. The plurality of mold surfaces 446 collectively constitute an interior surface. Preferably, each of the mold surfaces 446 comprises a rounded portion 447. The inner mold component 442 comprises a round exterior surface 452. The interior surface of the outer mold component 444 and the round exterior surface 452 collectively define an internal region capable of receiving liquid concrete. Preferably, the inner mold component 442 and/or the outer mold component 444 comprises a plurality of blockouts 454 (e.g. protruding pieces of sheet metal extending away from a surface) capable of being adjusted. More specifically, preferably the interior surface of the outer mold component 444 and/or the round exterior surface 452 of the inner mold component 442 comprises a plurality of blockouts 454 capable of being adjusted. When the inner mold component 442 is located within the outer mold component 444, the plurality of blockouts 454 define at least one blockout region that does not receive liquid concrete during the manufacturing process of a stormwater module, thereby forming windows in the stormwater module.

After the inner mold component 442 is located within the outer mold component 444, liquid concrete is poured between the interior surface of the outer mold component and the exterior surface 452 of the inner mold component so as to at least partially fill the internal region. The liquid concrete is allowed to cure to form the stormwater management module. After the liquid concrete cures, the stormwater management module is separated from the inner and outer mold components 442, 444. To separate the outer mold component 444 from the module, the walls 445 of the outer mold component are unlatched from each other. FIG. 15 shows the walls 445 in an unlatched configuration in dashed lines. Preferably, the outer mold component 444 further comprises a track system 448 comprising a plurality of rails 449. The track system 448 is adapted such that the walls 445 are capable of being slid away from each other along the rails 449. FIG. 15 shows the walls 445 of the outer mold component 444 slid away from each other via the track system 448 in dashed lines. To separate the inner mold component from 442 from the module, the inner mold component is collapsed along a seam (not shown), reducing the width of the inner mold component and enabling the inner mold component to be removed from the module.

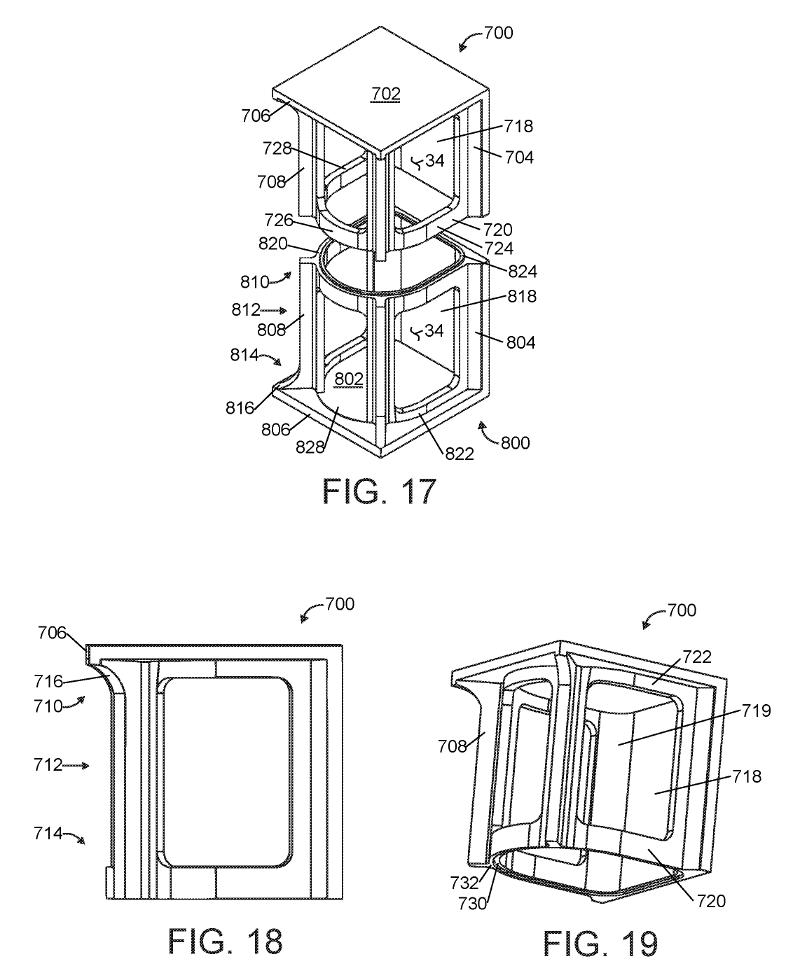

Another embodiment of a cell 700 capable of being located within the upper level of cells 404 is shown in FIGS. 17-19. Cell 700 is similar to cell 408. Cell 700 comprises a top portion 702 and a body portion 704. The top portion 702 has an outermost edge surface 706. The body portion 704 comprises four corner columns 708 spaced from each other. Each corner column 708 comprises a top region 710, an intermediate region 712, and an bottom region 714. The intermediate region 712 extends from the top region 710 to the bottom region 714. At least two of the corner columns 708 of cell 700 are shaped such that the bottom region 714 and the intermediate region 712 of each corner column are spaced inwardly from the outermost edge surface 706 of the top portion 702. The top regions 710 of these corner columns 708 are curved or shaped such that a portion of the top region (e.g., tapered portion 716) extends to the outermost edge surface 706. Because the bottom region 714 and the intermediate region 712 of the two corner columns 708 are spaced inwardly from the outermost edge surface 706 of the top portion 702, stormwater is capable of flowing around the corner columns to an adjacent cell without passing through the internal region 34 of cell 700.

The bottom region 714 and the intermediate region 712 of less than all of the corner columns 708 are not spaced inwardly from the outermost edge surface 706 such that stormwater is not capable of flowing around some (but not all) of the corner columns 708 without passing through the internal region 34 of the cell. For example, and without limitation, the two corner columns 708 adjacent a side wall 718 are not spaced inwardly from the outermost edge surface 706 and do not include tapered portions 716.

The corner columns 708 and/or other portions of the body 704 of the cell 700 may have a curved interior surface. More specifically, an inner surface 719 of at least some portions of the body portion 704 is arcuate. The inner surface 719 or portions thereof may be arcuate while at least a portion of the exterior of the body portion 704 is not arcuate. The inner surfaces 719 of the plurality of collectively constitute an interior surface. The interior surface may be of a shape that is generally a right circular cylinder or a portion of a right circular cylinder. The interior surface at least partially surrounds the internal region 34 of the cell 700.

Cell 700 is adapted and configured to form the perimeter of the underground system 400. Cell 700 includes a side wall 718. Side wall 718 extends between two of the four corner columns 708. The side wall 718 also extends from the top portion 702 to the opposite side of the body portion 704. The side wall 718 prevents stormwater from exiting the corresponding side of the cell 700. This allows a plurality of cells 700 to be positioned along the perimeter of the underground system 400 to contain the stormwater within the underground system 400.

The cell 700 includes a first horizontal member 720 and a second horizontal member 722. The second horizontal member 722 is positioned adjacent the top portion 702, and the first horizontal member 720 is positioned opposite the second horizontal member 722. Each of the first and second horizontal members includes a first portion 724, a second portion 726, and a third portion 728. The first portion 724 extends away from away from the side wall 718 and is substantially straight. The first portion 724 ends before it reaches the corner column 708 opposite the side wall 718. For example, and without limitation, the first portion 724 extends for a distance substantially half the distance between the edge surface 706 adjacent the side wall 718 and the edge surface 706 opposite the side wall 718. In other embodiments, the first portion 724 extends for a distance substantially 40%, 60%, 70%, 75%, 80%, or a value in between, of the distance between the edge surface 706 adjacent the side wall 718 and the opposite edge surface 706. The third portion 728 similarly extends from the side wall 718 towards a column 708 opposite the side wall 718. The third portion 728 is positioned opposite the first portion 724 such that the third portion 728 extends from the side wall 718 and is substantially parallel to the first portion 724. The third portion 728 has a length equal to that of the first portion 724. The third portion 726 is curved, e.g., is substantially semicircular, and extends from the first portion 724 to the third portion 728. The curvature of the third portion may be substantially similar to the curvature of other portions of the body portion 704. For example, and without limitation, the interior surface of the horizontal member(s) may be of a shape that is generally a right circular cylinder or a portion of a right circular cylinder. The third portion 728 is curved inward towards the internal region 34 of the cell.

The first, second, and third portions may be integrally cast with the entirety of the cell 700 or otherwise constructed with suitable methods. The first horizontal member 720 may increase the rigidity of the cell 700 by coupling the corner columns 708 to the side wall 718. The first horizontal member 720 may prevent buckling of the corner columns 708. The second horizontal member 722 may similarly increase the rigidity of the cell 700 and may similarly prevent buckling of the corner columns 708. In some embodiments, the curved shape of one or more of the horizontal members enhances the strength of the cell. For example, and without limitation, the curved shape may increase the hoop stress value at which the cell fractures, deforms, and/or yields. In some embodiments, the curved shape of one or more of the horizontal members reduces the amount of materials, e.g., concrete, used in the production of a cell in comparison to a cell with straight, un-curved features. The reduction in materials used may be the result of geometry of the cell, the increased strength of the curved configuration, or a combination of the two. The curved interior surface 719 of the body portion of the cell 700 may provide the same or similar benefits. These benefits may also apply to any of the cells described herein having the same or similar constructions, e.g., using a cell body and/or horizontal member with at least one curved portion.

Another embodiment of a cell 800 capable of being located within the lower level of cells 406 is also shown in FIG. 17. Cell 800 is similar to cell 410. Cell 800 comprises a bottom portion 802 and a body portion 804. The bottom portion 802 has an outermost edge surface 806. The body portion 804 comprises four corner columns 808 spaced from each other. Each of the corner columns 808 comprises a top region 810, a bottom region 814, and an intermediate region 812. The intermediate region 812 extends from the top region 810 to the bottom region 814. At least two of the corner columns 808 of cell 800 are shaped such that the top region 810 and the intermediate region 812 of the two corner columns are spaced inwardly from the outermost edge surface 806 of the bottom portion 802. The bottom region 814 of the two corner columns 808 are curved or otherwise shaped such that a portion of the bottom region (e.g., tapered portion 816) extends to the outermost edge surface 806. Because the top region 810 and the intermediate region 812 of the two corner columns 808 are spaced inwardly from the outermost edge surface 806 of the bottom portion 802, stormwater is capable of flowing around the two corner columns to an adjacent cell without passing through the internal region 34 of cell 800. Depending upon the arrangement of the cells and the types of cells used within a lower level of a stormwater management system, the capability of stormwater to flow around some or all of the corner columns of a cell without passing through an internal region of said cell could prevent a damming or pooling effect in the stormwater management system.

In some embodiments, the cell 800 is substantially identical to the cell 700. The cell 800 is oriented 180 degrees relative to the cell 700 such that the cell 800 is positioned in the lower level 406 below cell 700 of the upper level 404. Cell 800 includes a first horizontal member 820 and a second horizontal member 822. The second horizontal member 822 is positioned adjacent the top portion 802, and the first horizontal member 820 is positioned opposite the second horizontal member 822. The first and second horizontal members 820,822 may be identical to the first and second horizontal members 720, 722 of the cell 700.

In alternative embodiments, and as depicted in FIG. 17, cell 800 differs from cell 700. The cell 800 includes a first horizontal member 820 substantially identical to the first horizontal member 720 of the cell 700, but cell 800 includes a second horizontal member 822 that differs from the second horizontal member 722 of the cell 700. For example, and without limitation, the second horizontal member 822 may extend to an opening 828 that extends between the pair of corner columns 808 opposite the side wall 818. The second horizontal member 822 extends from the side wall 818 to a first corner column 808 opposite the side wall and extends from the side wall 818 to a second corner column 808 opposite both the side wall 818 and the first corner column 808. The opening 828 may permit stormwater to flow with fewer obstructions and/or reduce the amount of materials used in building the cell 800. Other than the opening 828, the second horizontal member 822 may be identical to the second horizontal member 722 of cell 700.

In some embodiments, the cell 700 optionally includes a recessed portion 730 (e.g., a groove) of the bottom 732 surface of the cell 700, and the cell 800 optionally includes a tongue 824. The recessed portion 730 and the tongue 824 are adapted and configured to cooperate to mate the cell 700 with the cell 800. The tongue 824 is received within the recessed portion 730 with the cooperation between the tongue 824 and the recessed portion 730 aligning the cell 700 and the cell 800 axially.

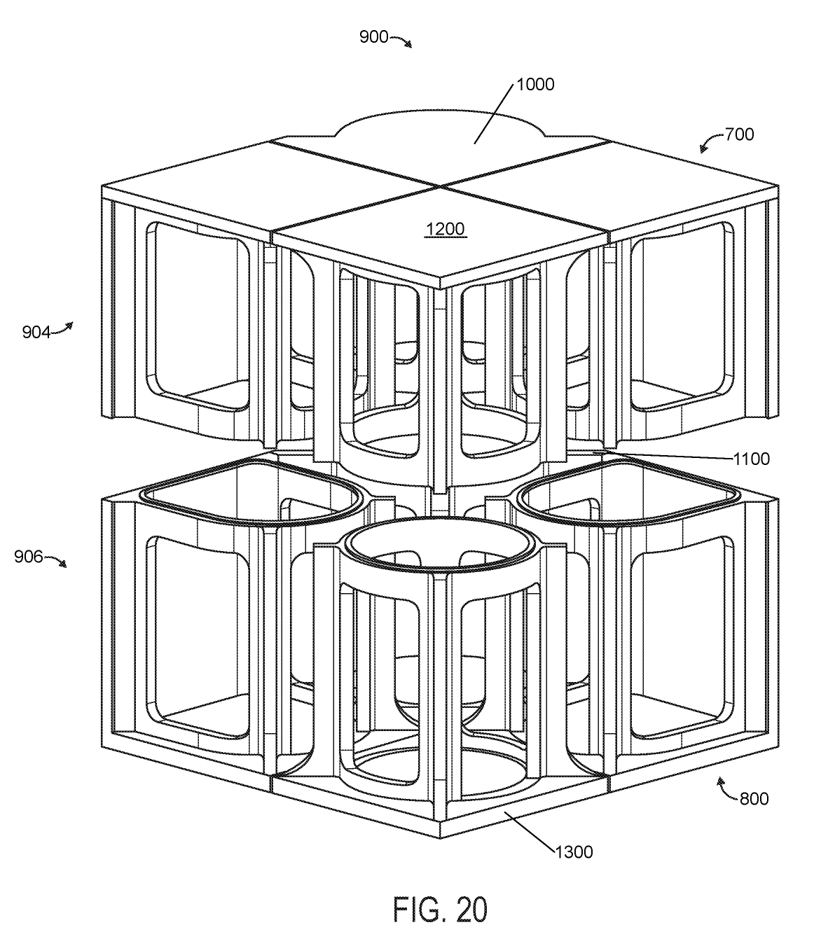

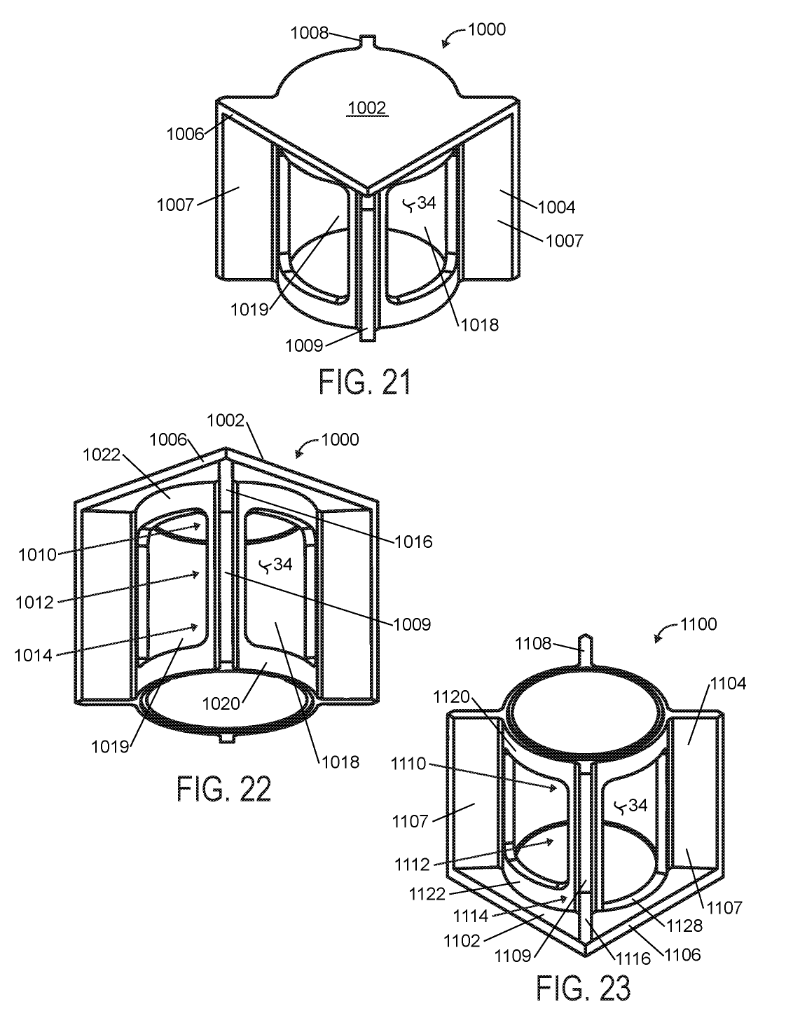

Another embodiment of a stormwater management system is shown in FIG. 20 in an exploded view of a portion of the system and indicated generally by reference numeral 900. The stormwater management system 900 includes at least an upper level 904 of cells and a lower level 906 of cells. The system 900 includes a perimeter of cells including cells 700 in the upper level 904 and cells 800 in the lower level 906. The perimeter is further formed by corner cells 1000 included in the upper level 904 and corner cells 1100 included in the lower level 906. The corner cells 1000, 1100 may be of the type depicted in FIG. 12, the type depicted in FIGS. 21-23, cells 700 or cells 800 with an additional side wall 718, or another suitable cell as described herein. The stormwater management system 900 further includes interior cells 1200 in the upper level 904 and interior cells 1300 in the lower level 906.

Another embodiment of a cell 1000 capable of being located within the upper level of cells 904 is shown in FIGS. 21-22. Cell 1000 is similar to cell 408. Cell 1000 comprises a top portion 1002 and a body portion 1004. The top portion 1002 has an outermost edge surface 1006. The body portion 1004 comprises four corner columns spaced from each other. Two of the four corner columns 1007 extend outward on opposite sides of the cell and extend to the extremes of the cell 1000. One corner column 1008 extends outward to a point that is radially closer to the center of the cell 1000 than the points to which the corner columns 1007 extend. The fourth corner column 1009 extends outward opposite the corner column 1008. The fourth corner column 1009 comprises a top region 1010, an intermediate region 1012, and an bottom region 1014. The intermediate region 1012 extends from the top region 1010 to the bottom region 1014. The fourth corner column 1009 of cell 1000 is shaped such that the bottom region 1014 and the intermediate region 1012 are spaced inwardly from the outermost edge surface 1006 of the top portion 1002. The top region 1010 of the fourth corner column 1009 is curved or shaped such that a portion of the top region (e.g., tapered portion 1016) extends to the outermost edge surface 1006. Because the bottom region 1014 and the intermediate region 1012 of the fourth corner column 1009 are spaced inwardly from the outermost edge surface 1006 of the top portion 1002, stormwater is capable of flowing around the fourth corner column 1009 to an adjacent cell without passing through the internal region 34 of cell 1000.

The cell 1000 further includes a first side wall 1018 and a second side wall 1019. The first side wall 1018 prevents stormwater from exiting the stormwater system from one of the four sides of the cell 1000. The second side wall 1019 prevents stormwater from exiting an adjacent side. The cell 1000 further includes a first horizontal member 1020 and a second horizontal member 1022. Both the first and second horizontal members include at least a portion that is curved inward towards the internal region 34 of the cell. In some embodiments, the first and second horizontal members are semicircular or circular, e.g., partially forming the first and second side walls.

The second horizontal member 1022 is positioned adjacent the top portion 1002, and the first horizontal member 1020 is positioned opposite the second horizontal member 1022. The first horizontal member 1020 may increase the rigidity of the cell 1000 by coupling the corner columns to the side walls 1018, 1019. The first horizontal member 720 may prevent buckling of the fourth corner columns 1009. The second horizontal member 1022 may similarly increase the rigidity of the cell 1000 and may similarly prevent buckling of the fourth corner column 1009.

Another embodiment of a cell 1100 capable of being located within the lower level of cells 906 is shown in FIG. 23. Cell 1100 is similar to cell 410. Cell 1100 comprises a bottom portion 1102 and a body portion 1104. The bottom portion 1102 has an outermost edge surface 1106. The body portion 1104 comprises four corner columns spaced from each other. Two of the four corner columns 1107 extend outward on opposite sides of the cell and extend to the extremes of the cell 1100. One corner column 1108 extends outward to a point that is radially closer to the center of the cell 1100 than the points to which the corner columns 1107 extend. The fourth corner column 1109 extends outward opposite the corner column 1108. The fourth corner column 1109 comprises a top region 1110, an intermediate region 1112, and an bottom region 1114. The intermediate region 1112 extends from the top region 1110 to the bottom region 1114. The fourth corner column 1109 of the cell 1100 is shaped such that the top region 1110 and the intermediate region 1112 are spaced inwardly from the outermost edge surface 1106 of the bottom portion 1102. The bottom region 1114 of the fourth corner column 1109 is curved or shaped such that a portion of the bottom region (e.g., tapered portion 1116) extends to the outermost edge surface 1106. Because the top region 1110 and the intermediate region 1112 of the fourth corner column 1109 are spaced inwardly from the outermost edge surface 1106 of the bottom portion 1102, stormwater is capable of flowing around the fourth corner column 1109 to an adjacent cell without passing through the internal region 34 of cell 1100.

In some embodiments, the cell 1100 is substantially identical to the cell 1000. The cell 1100 is oriented 180 degrees relative to the cell 1000 such that the cell 1100 is positioned in the lower level 906 below cell 1000 of the upper level 904. Cell 1100 includes a first horizontal member 1120 and a second horizontal member 1122. The second horizontal member 1122 is positioned adjacent the bottom portion 1102, and the first horizontal member 1120 is positioned opposite the second horizontal member 1122. The first and second horizontal members 1120, 1122 may be identical to the first and second horizontal members 1020, 1022 of the cell 1000.

In alternative embodiments, and as depicted in FIG. 23, cell 1100 differs from cell 1000. The cell 1100 includes a first horizontal member 1120 substantially identical to the first horizontal member 1120 of the cell 1000, but cell 1100 includes a second horizontal member 1122 that differs from the second horizontal member 1122 of the cell 1000. For example, and without limitation, the second horizontal member 1122 may extend to an opening 1128 that extends between one of the corner columns 1107 and the fourth corner column 1109. The second horizontal member 1122 extends between the fourth corner column 1109 and the other corner column 1107 opposite the corner column 1107 to which the opening 1128 extends. The opening 1128 may permit stormwater to flow with fewer obstructions and/or reduce the amount of materials used in building the cell 1100. Other than the opening 1128, the second horizontal member 1122 may be identical to the second horizontal member 1122 of cell 1000.

Cells 1000 and 1100 may include tongues and recesses as described herein. The tongue of one cell cooperates with the recess of the other cell in a stacked pair to facilitate alignment and coupling of the cells as described herein.

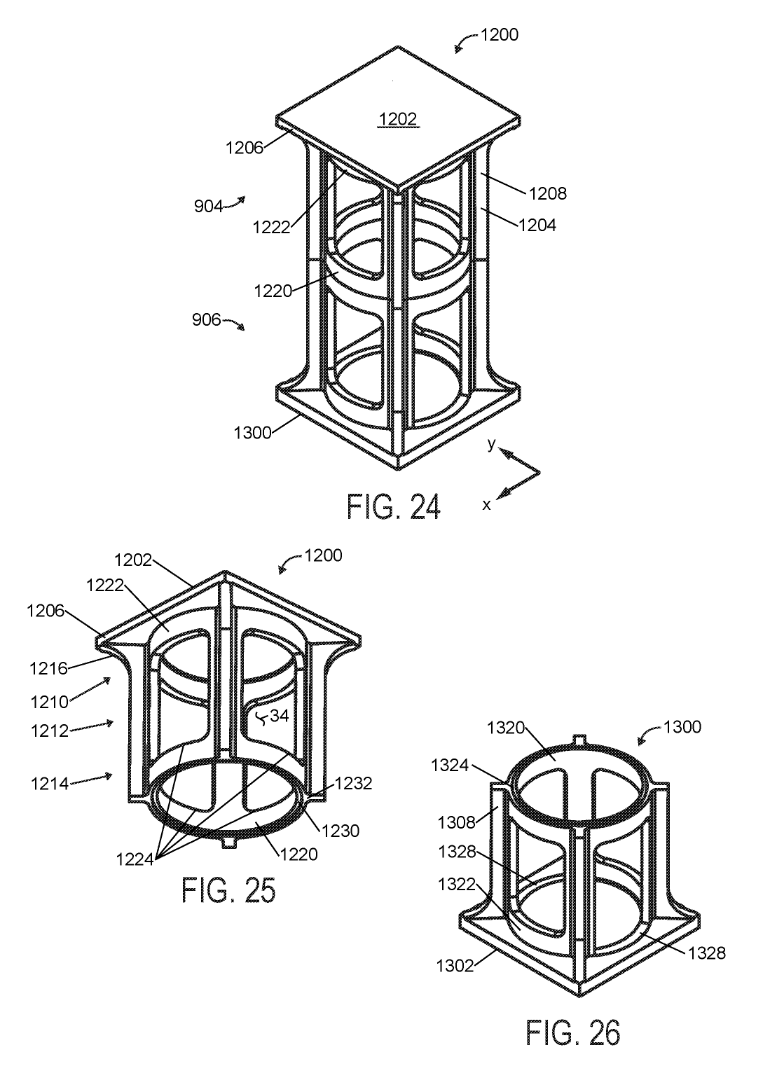

An embodiment of a cell 1200 capable of being located within the interior of the upper level of cells 904 is shown in FIGS. 24 and 25. Cell 1200 is similar to cell 408 and cell 500. Cell 1200 comprises a top portion 1202 and a body portion 1204. The top portion 1202 has an outermost edge surface 1206. The body portion 1204 comprises four corner columns 1208 spaced from each other. Each corner column 1208 comprises a top region 1210, an intermediate region 1212, and a bottom region 1214. The intermediate region 1212 extends from the top region 1210 to the bottom region 1214. Each corner column 1208 of cell 1200 is shaped such that the bottom region 1214 and the intermediate region 1212 of each corner column are spaced inwardly from the outermost edge surface 1206 of the top portion 1202. The top region 1210 of each corner column 1208 is curved or shaped such that a portion of the top region (e.g., tapered portion 1216) extends to the outermost edge surface 1206. Because the bottom region 1214 and the intermediate region 1212 of each corner column 1208 are spaced inwardly from the outermost edge surface 1206 of the top portion 502, stormwater is capable of flowing around each of the corner columns to an adjacent cell without passing through the internal region 34 of cell 1200. It is to be understood that in an alternative embodiment of cell 1200, the bottom region 1214 and the intermediate region 1212 of less than all of the corner columns 1208 could be spaced inwardly from the outermost edge surface 1206 such that stormwater is capable of flowing around some (but not all) of the corner columns 1208 without passing through the internal region 34 of the cell. It is also to be understood that in an alternative embodiment of cell 1200, the top region 1210, the bottom region 1214, and the intermediate region 1212 of each (or some) of the corner columns 1208 could be spaced inwardly from the outermost edge surface 1206 of the top portion 1202.

The cell 1200 further includes a first horizontal member 1220 and a second horizontal member 1222. The first and second horizontal members are curved inward towards the internal region 34 of the cell. For example, and without limitation, the first at and second horizontal members may be circular or at least partially circular. The second horizontal member 1222 is positioned adjacent the top portion 1202, and the first horizontal member 1220 is positioned opposite the second horizontal member 1222. The first horizontal member 1220 may increase the rigidity of the cell 1200 by coupling the corner columns to adjacent corner columns. The first horizontal member 1220 may prevent buckling of the corner columns 1208. The second horizontal member 1222 may similarly increase the rigidity of the cell 1000 and may similarly prevent buckling of the corner columns 1208.

In some embodiments, the body portion 1204 is a single monolithic support. The body portion 1204, as a single monolithic support, supports the top portion 1202. The single monolithic support formed by the body includes the body portion 1204, the first horizontal member 1220, the second horizontal member 1222, and the corner columns 1208. The single monolithic support formed by the body of the cell 1200 includes a plurality of windows 1224 with each window of the plurality of windows extending between a pair of adjacent corner columns 1208 and extending between the first horizontal member 1220 and the second horizontal member 1222. The windows 1224 may be the same as or similar to the windows described herein with reference to other cells. Furthermore, other cells described herein may be of the same construction providing for a body that forms a single monolithic support.

The body of the cell 1200 is substantially cylindrical. For example, and without limitation, the body portion 1204 forms a curved interior surface which is substantially cylindrical and the exterior surface of the body portion 1204 is substantially cylindrical with the four corner columns 1208 being arranged about the cylinder. The top portion 1202 is cantilevered relative to the body portion 1204 such that the top portion 1202 extends radially outward from substantially an entire circumference of the body portion 1204. For example, and without limitation, the top portion 1202 is generally square with each side having a length greater than the diameter of the substantially cylindrical body portion 1204. The top portion 1202 is centered about an axis extending through the center point of the body portion 1204 such that each side of the top portion 1202 overhangs the body portion 1204 and is cantilevered. In some embodiments, the tapered portions 1216 of the corner columns extend substantially to the edge 1206 of the top portion 1202. In such embodiments, the top portion 1202 may be entirely cantilevered or cantilevered in areas other than the tapered portions 1216. In alternative embodiments, the tapered portions 1216 may be absent or may not extend to the edge 1206 of the top portion 1202.

In some embodiments, the cell 1200 is substantially symmetrical about a first axis. The first axis is parallel to the y axis. The cell 1200 is also substantially symmetrical about a second axis. The second axis is parallel to the x axis. The first axis is perpendicular to the second axis, and the y axis is perpendicular to the x axis. The symmetry of the cell 1200 allows the cell 1200 to have substantially equal strength along both the x axis and the y axis, and therefore the cell 1200 responds substantially equally to force, including shear force, along either the x axis or the y axis. Advantageously, this simplifies installation of a stormwater management system as the cell 1200 cannot be installed in an incorrect orientation in the x-y plane if the cell 1200 is flush to an adjacent cell. Furthermore, the symmetry of the cell 1200 and the resulting strength increases the overall strength of the stormwater management system. For example, and without limitation, the stormwater management system does not have a substantially weaker or stronger direction when experiencing a shear stress at an unknown angle parallel to the x-y plane, e.g., in the case of an earthquake or other seismic event. Similar advantages and properties may apply to other cells described herein including, to a lesser degree, those cells which are not perfectly symmetrical about an x and y axis.

An embodiment of a cell 1300 capable of being located with the interior of the lower level of cells 906 is shown in FIGS. 24 and 26. In some embodiments, the cell 1300 is substantially identical to the cell 1200. The cell 1300 is oriented 180 degrees relative to the cell 1200 such that the cell 1300 is positioned in the lower level 906 below cell 1200 of the upper level 904. Cell 1300 includes a first horizontal member 1320 and a second horizontal member 1322. The second horizontal member 1322 is positioned adjacent the bottom portion 1302, and the first horizontal member 1320 is positioned opposite the second horizontal member 1322. The first and second horizontal members 1320, 1322 may be identical to the first and second horizontal members 1220, 1222 of the cell 1200.

In alternative embodiments, and as depicted in FIG. 26, cell 1300 differs from cell 1200. The cell 1200 includes a first horizontal member 1320 substantially identical to the second horizontal member 1220 of the cell 1200, but cell 1300 includes a second horizontal member 1322 that differs from the second horizontal member 1222 of the cell 1200. For example, and without limitation, the second horizontal member 1322 may include an opening 1328 that extends between a first pair of corner columns 1308 and a second opening 1328 that extends between a second pair of corner columns 1308. The opening 1328 may permit stormwater to flow with fewer obstructions and/or reduce the amount of materials used in building the cell 1300. Other than the opening 1328, the second horizontal member 1322 may be identical to the second horizontal member 1222 of cell 1200.

In some embodiments, the cell 1200 optionally includes a recessed portion 1230 of the bottom 1232 surface of the cell 1200, and the cell 1300 optionally includes a tongue 1324. The recessed portion 1230 and the tongue 1324 are adapted and configured to cooperate to mate the cell 1200 with the cell 1300. The tongue 1324 is received within the recessed portion 1230 with the cooperation between the tongue 1324 and the recessed portion 1230 aligning the cell 1200 and the cell 1300 axially.

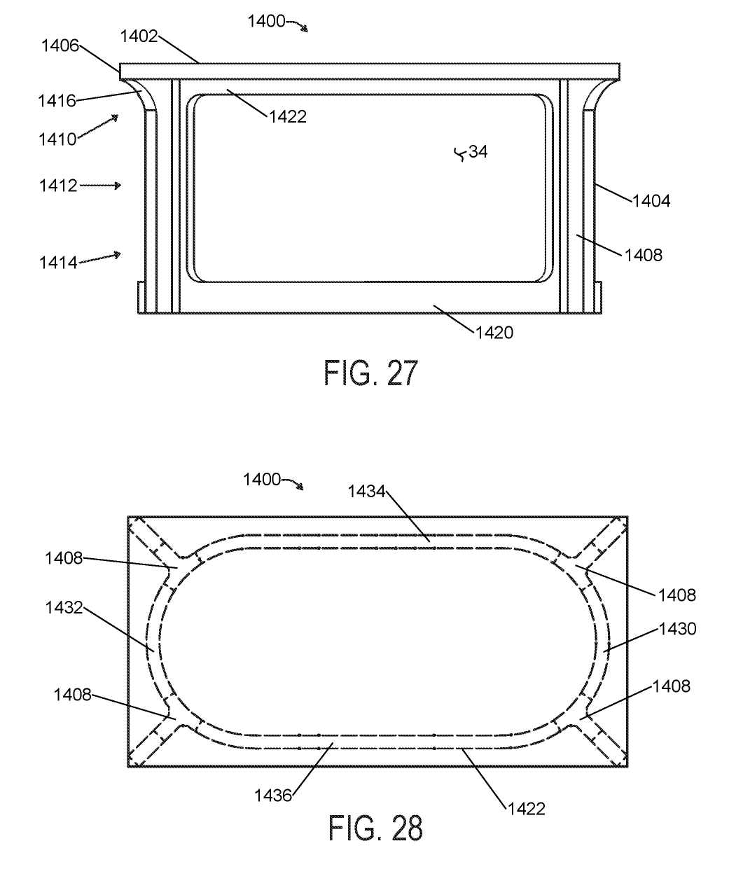

An alternative embodiment of a cell 1400 is depicted in FIGS. 27 and 28. FIG. 27 depicts a side view of the cell 1400, and FIG. 28 depicts a top view of the cell 1400. The cell 1400 is similar to cell 408 and cell 500. Cell 1400 comprises a top portion 1402 and a body portion 1404. The top portion 1402 has an outermost edge surface 1406. The body portion 1404 comprises four corner columns 1408 spaced from each other. Each corner column 1408 comprises a top region 1410, an intermediate region 1412, and a bottom region 1414. The intermediate region 1412 extends from the top region 1410 to the bottom region 1414. Each corner column 1408 of cell 1400 is shaped such that the bottom region 1414 and the intermediate region 1412 of each corner column are spaced inwardly from the outermost edge surface 1406 of the top portion 1402. The top region 1410 of each corner column 1408 is curved or shaped such that a portion of the top region (e.g., tapered portion 1416) extends to the outermost edge surface 1406. Because the bottom region 1414 and the intermediate region 1412 of each corner column 1408 are spaced inwardly from the outermost edge surface 1406 of the top portion 1402, stormwater is capable of flowing around each of the corner columns to an adjacent cell without passing through the internal region 34 of cell 1400. It is to be understood that in an alternative embodiment of cell 1400, the bottom region 1414 and the intermediate region 1412 of less than all of the corner columns 1408 could be spaced inwardly from the outermost edge surface 1406 such that stormwater is capable of flowing around some (but not all) of the corner columns 1408 without passing through the internal region 34 of the cell. It is also to be understood that in an alternative embodiment of cell 1400, the top region 1410, the bottom region 1414, and the intermediate region 1412 of each (or some) of the corner columns 1408 could be spaced inwardly from the outermost edge surface 1406 of the top portion 1402.

The cell 1400 further includes a first horizontal member 1420 and a second horizontal member 1422. The second horizontal member 1422 is positioned adjacent the top portion 1402, and the first horizontal member 1420 is positioned opposite the second horizontal member 1422. The first horizontal member 1420 may increase the rigidity of the cell 1400 by coupling the corner columns to adjacent corner columns. The first horizontal member 1420 may prevent buckling of the corner columns 1408. The second horizontal member 1422 may similarly increase the rigidity of the cell 1400 and may similarly prevent buckling of the corner columns 1408.

The second horizontal member 1422 is at least partially curved inward towards the internal region of the cell and includes a first semicircular portion 1430, a second semicircular section 1432. The second horizontal member 1422 further includes a first linear portion 1434 and a second linear portion 1436. The first linear portion 1434 extends between corresponding first ends of the first semicircular portion 1430 and the second semicircular section 1432. The second linear portion 1436 extends between corresponding second ends of the first semicircular portion 1430 and the second semicircular section 1432. The first and second linear portions 1434,1436 are substantially straight and are substantially parallel. The first and second semicircular portions each have a subtended angle of substantially 180 degrees. In alternative embodiments, the first and second semicircular portions 1430,1432 may have alternative geometries and may not be perfectly semicircular, but the first and second semicircular portions 1430,1432 have a substantial curvature.

In some embodiments, the first horizontal member 1420 and the second horizontal member 1422 are substantially identical. In alternative embodiments, the first horizontal member 1420 differs from the second horizontal member 1422. For example, and without limitation, the first horizontal member 1420 may include one or more openings of the type described with reference to openings 1328 and FIG. 26. An opening may extend between a first pair of the corner columns, and a second opening may extend between a second pair of the corner columns. The opening(s) may permit stormwater to flow with fewer obstructions and/or reduce the amount of materials used in building the cell. Other than the opening(s), the first horizontal member 1420 may be identical to the second horizontal member 1422.

Cell 1400 may be used in an upper or lower level of cells of the stormwater management systems described herein. In some embodiments, a stormwater system that includes the cell 1400 includes only rectangular cells similar to cell 1400. For example, and without limitation, the cell 1400 may be modified to form side perimeter and corner perimeter cells. The cells 1400 may be modified to include one or more side walls such as the cells described herein. In alternative embodiments, a stormwater management system may include a combination of cells having different dimensions or configurations. For example, and without limitation, a stormwater management system may include a combination of rectangular cells, such as the cell 1400, and square cells such as those described with reference to FIGS. 17 through 26.

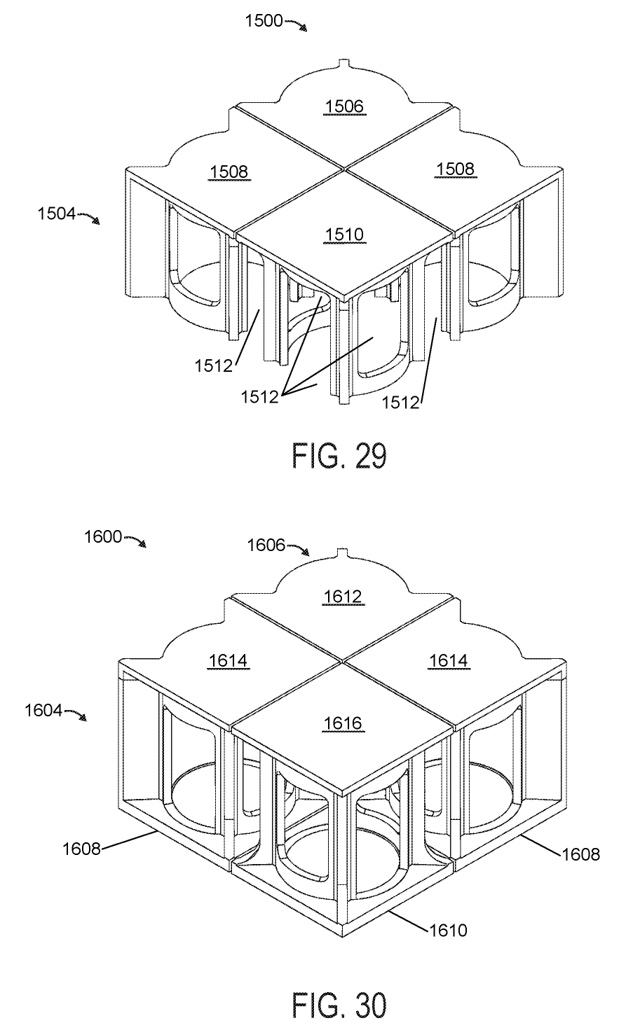

An alternative embodiment of a stormwater management system 1500 is partially depicted in FIG. 29. The stormwater management system 1500 includes cells in a single level 1504. The stormwater management system 1500 includes cells of the type described with reference to FIGS. 17 through 28. For example, and without limitation, the stormwater management system 1500 includes one or more corner cells 1506 and one or more side cells 1508. In combination, the corner cells 1506 and the side cells 1508 form a perimeter of the stormwater management system 1500. The stormwater management system 1500 further includes one or more interior cells 1510 positioned within the perimeter of the stormwater management system 1500. The corner cells 1506 may be one or more of the cells 1000 described with reference to FIGS. 21 or any other suitable cell as described herein. The side cells 1508 may be one or more of the cells 408, 500, 700, 1400 described with reference to FIGS. 13, 14a, 17-19, and 27 or any other suitable cell as described herein. The interior cells 1510 may be one or more of the cells 500, 1200, 1400 described with reference to FIGS. 14a, 24-25, and 27 or any other suitable cell as described herein. The cells of the stormwater management system 1500 may be modified to include one or more openings 1512 in corresponding first horizontal members of the type described herein. The stormwater management system 1500 includes top portions but does not include bottom portions. For example, and without limitation, the cells of the stormwater management system 1500 may be placed on a gravel bed, unprepared surface, poured concrete pad, or other suitable surface.

An alternative embodiment of a stormwater management system 1600 is partially depicted in FIG. 30. The stormwater management system 1600 includes cells in a single level 1604. The stormwater management system 1600 includes cells of the type described with reference to FIGS. 17 through 28. For example, and without limitation, the stormwater management system 1600 includes one or more corner cells 1606 and one or more side cells 1608. In combination, the corner cells 1606 and the side cells 1608 form a perimeter of the stormwater management system 1600. The stormwater management system 1600 further includes one or more interior cells 1610 positioned within the perimeter of the stormwater management system 1600. The corner cells 1606 may be one or more of the cells 1000 described with reference to FIGS. 21 or any other suitable cell as described herein. The side cells 1608 may be one or more of the cells 408, 500, 700, 1400 described with reference to FIGS. 13, 14a, 17-19, and 27 or any other suitable cell as described herein. The interior cells 1610 may be one or more of the cells 500, 1200, 1400 described with reference to FIGS. 14a, 24-25, and 27 or any other suitable cell as described herein.

The stormwater management system 1600 includes a series of top portions placed on top of corresponding cells. A top portion 1612 corresponds with the corner cell 1606. The top portion 1612 may have a perimeter that corresponds to the outer facing perimeter of the cell 1606 and is square on the sides facing inward of the stormwater management system 1600. For example, and without limitation, the top portion 1612 includes two straight sides and two sides that follow the perimeter of the cell 1606. A top portion 1614 corresponds with the side cell 1608. The top portion 1614 may have a perimeter that corresponds to the outer facing perimeter of the cell 1608 and is square on the sides facing inward of the stormwater management system 1600. For example, and without limitation, the top portion 1614 includes three straight sides and a side that follows the perimeter of the cell 1608. A top portion 1616 corresponds with the interior cell 1616. The top portion 1616 is square such that the four sides are adjacent the straight sides of adjacent top portions.

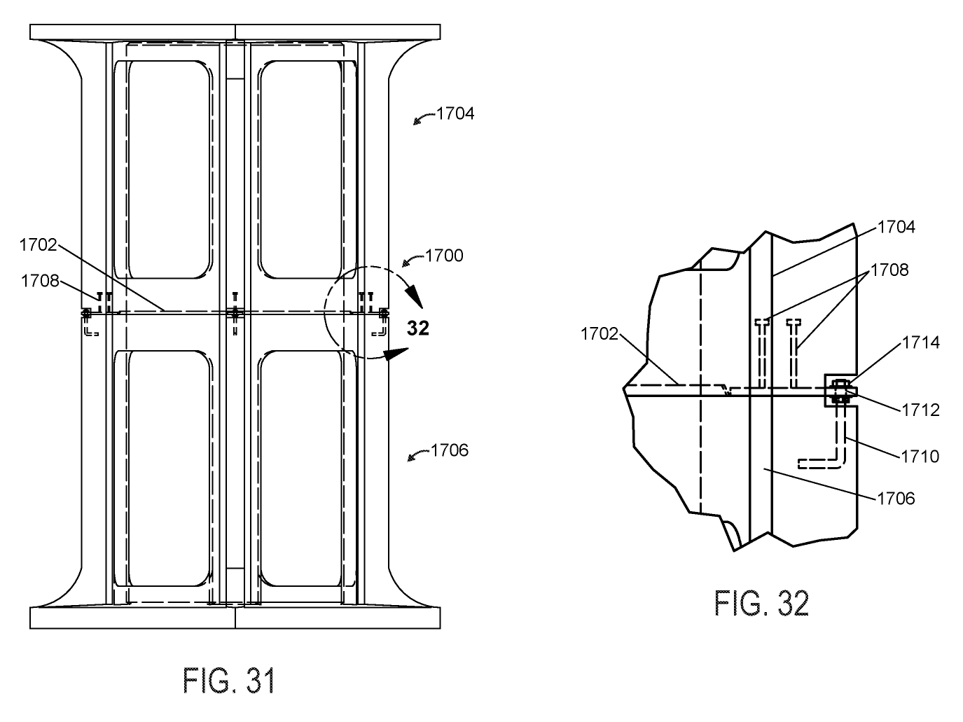

A system 1700 for coupling two cells together is depicted in FIG. 31 and a detail view is depicted in FIG. 32. The system 1700 may be used in conjunction with any of the cells depicted or described herein. The system includes a plate 1702 coupled to one of the two cells, e.g., upper cell 1704 or lower cell 1706. For example, and without limitation, the plate 1702 may be coupled to the upper cell 1704 by anchors 1708 that are coupled to or form a portion of the plate 1702 and about which the upper ell 1704 is cast. A threaded anchor 1710 is embedded in the lower cell 1706. For example, and without limitation, the lower cell 1706 is cast about the threaded anchor 1710. The plate 1702 includes aa plurality of through holes 1712 corresponding to each threaded anchor 1710. The plurality of through holes 1712 collectively define a bolt pattern.

To couple the upper cell 1704 to the lower cell 1706, each threaded anchor 1710 is inserted into the corresponding opening 1712 of the plate 1702. A nut 1714, and optionally other fastener hardware such as washers or lock washers, are coupled to the portion of each threaded anchor 1710 extending through the opening 1712. The nut 1714 is tightened to couple the two cells together. In alternative embodiments, the upper cell 1704 and the lower cell 1706 may be coupled together using alternative suitable techniques such as adhesives, welding of imbedded features (e.g., anchors of flanges), gusset plates, or the like.

The system 1700, including the plate 1702 and threaded anchors 1710, provides for a secure connection between cells in upper and lower levels of a stormwater management system. Advantageously, the system 1700 secures the cells such that movement between a cell in the upper level and an adjacent cell in the lower is substantially prevented or reduced compared to a stormwater management system without the system 1700 for securing cells. This may prevent or reduce movement of the upper level of cells relative to the lower level of cells when the stormwater management system experiences shearing forces, e.g., in an earthquake or other seismic event. The system 1700 may also provide additional structural integrity to the stormwater management system as a whole by maintaining the cells in the upper level and lower level in axial alignment with each other.

In some embodiments, the threaded anchors 1710 and through holes 1712 of the plate 1702 are positioned symmetrically about the corresponding cells. For example, and without limitation, the cells may be substantially cylindrical such as the cells described with reference to FIGS. 24 through 26. In such a case, the threaded anchors 1710 and through holes 1712 are positioned at an equal distance radially from the center of the cells and with an equal arc length between each threaded anchor 1710 and between each through hole 1712. As described with reference to FIGS. 24 through 26 such a symmetrical configuration has several advantages, e.g., simplifying installation, handling stress equally well in multiple directions, and the like.

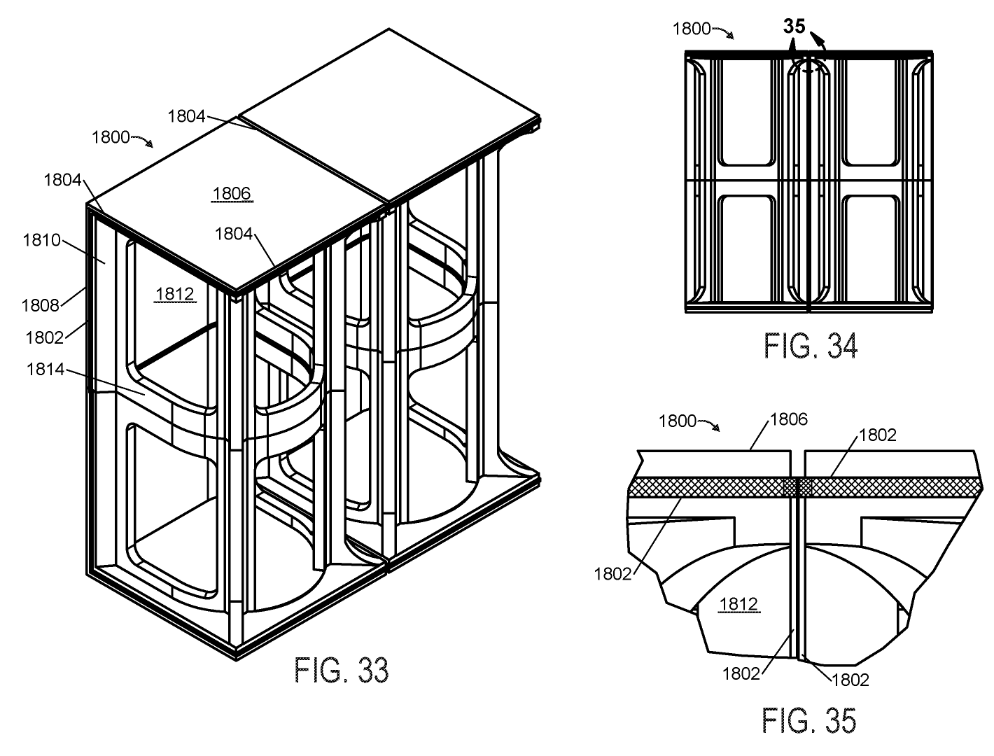

Another embodiment of a cell 1800 capable of being located within the stormwater system described herein is shown in FIGS. 33-35. The cell 1800 may be substantially similar to one or more of the cells described herein. For example, and without limitation, the cell 1800 may be substantially similar to the cell 700 described with reference to FIGS. 17-19. The cell 1800 includes features adapted and configured to form a seal between the cell 1800 and adjacent cells. The seal may be substantially watertight. Advantageously, such a substantially watertight seal enhances the ability of the stormwater management system to control the flow of stormwater and/or the detention of stormwater. The gaskets provide for a seal that substantially prevents groundwater or the like from entering into the stormwater management system. As a result, the stormwater management system receives water from the desired source, e.g., an inlet pipe. Similarly, the stormwater management system discharges water in a controlled fashion as a result of the seal formed by the gasket(s). For example, and without limitation, the seal may prevent or reduce leaking such that water is discharged from the system primarily from a discharge pipe. In alternative embodiments, water may be discharged from one or more cells directly into the ground, e.g., through openings in the bottom of one or more cells. In such an embodiment, the seal formed by the gasket(s) may control discharge of the water by preventing water from exiting the side of the system at the vertical connections between adjacent cells. Water is therefore controlled such that it exits the bottom of the system and at a controlled rate.

In some embodiments, the cell 1800 includes one or more gaskets 1802 or gasket material. The gasket 1802 extends along the periphery of the cell 1800 where the cell 1800 is adapted and configured to be placed adjacent other cells. For example, and without limitation, the gasket 1802 extends along the inward facing edges and/or surfaces of the cell 1802.

The gasket 1802 extends along the inward facing edges 1804 of the top portion 1806 of the cell 1800. The gasket 1802 further extends vertically along the inward facing edge 1808 of cell 1800. The inward facing edge 1808 runs along the corner column 1810 on one side of the side wall 1812. The gasket 1802 also extends vertically along the corner column 1810 on the opposite side of the side wall 1812. The gasket 1802 further extends along the bottom of the cell 1800. The gasket 1802 extends along a bottom edge of the side wall 1812, bottom edge of the four corner columns 1810, and the bottom edge of the first horizontal member 1814.

The gasket 1802 described with reference to cell 1800 may be used in conjunction with any of the cells depicted or described herein and/or any other combination of features described herein, e.g., the system 1700 for securing adjacent cells to one another. For example, a cell positioned in the interior of the stormwater management system, such as cell 1200 for example, has a gasket 1802 extending along all four sides of the top portion. The gasket 1802 further extends vertically along the four corner columns, and the gasket 1802 extends along the bottom edge of the first horizontal member.

For a cell positioned at the corner of the stormwater management system, such as cell 1000 for example, the gasket 1802 extends along two adjacent and interior facing sides of the top portion. The gasket further extends vertically along two opposite, non-adjacent, corner columns and along the bottom edge of the two side portions and any horizontal members.

Cells positioned in the lower level of a two level stormwater management system may include gaskets similar to those described for cells in the top level. However, the gasket extends along the sides of the bottom portion rather than the top portion, and the gasket extends along the top edge of any horizontal members and/or side walls rather than the bottom edges.

It should also be understood that when introducing elements of the present disclosure in the claims or in the above description of exemplary embodiments of the disclosure, the terms “comprising,” “including,” and “having” are intended to be open-ended and mean that there may be additional elements other than the listed elements. Additionally, the term “portion” should be construed as meaning some or all of the item or element that it qualifies. Location terms such as “top,” “bottom,” and “side” are intended to assist the reader in determining the relationship between features and it should be understood that the terms are not limiting. For example, and without limitation, a cell may be oriented such that the “top” portion is facing downward or sideways. Moreover, the order in which the steps of any method claim that follows are presented should not be construed in a manner limiting the order in which such steps must be performed.

What is claimed is:

1. A cell for a stormwater management system adapted for retaining or detaining stormwater, the cell comprising a body portion, an internal region, and at least one of a top portion or a bottom portion, the body portion comprising a plurality of corner columns spaced from each other, a first horizontal member, and a second horizontal member, at least one of the first and second horizontal members being adjacent the at least one of the top portion or the bottom portion and opposite the other horizontal member, the first horizontal member extending between at least two corner columns and having at least a portion curved inward towards the internal region, the second horizontal member extending between at least two corner columns and having at least a portion curved inward towards the internal region, and the first and second horizontal members being integrally formed with the body portion.

2. A cell as set forth in claim 1 further comprising a side wall, the side wall extending from a first of the corner columns to a second of the corner columns, the side wall further extending from the first horizontal member to the second horizontal member.

3. A cell as set forth in claim 2, wherein the first horizontal member includes a first portion extending away from the first of the corner columns adjacent the side wall and substantially perpendicular to the side wall, a second portion extending away from the second of the corner columns adjacent the side wall and both substantially perpendicular to the side wall and substantially parallel to the first portion, and a third portion extending in an arc from the first portion to a third corner column, from the third corner column to a forth corner column, and from the forth corner column to the second portion.

4. A cell as set forth in claim 3, wherein the second horizontal member includes a first portion, a second portion, and a third portion, the first portion of the second horizontal member extending away from a first corner column adjacent the side wall and substantially perpendicular to the side wall, the second portion of the second horizontal member extending away from a second corner column adjacent the side wall and both substantially perpendicular to the side wall and substantially parallel to the first portion, the third portion of the second horizontal member extending in an arc from the first portion to a third corner column and from the fourth corner column to the second portion, and wherein the cell includes a top portion, the second horizontal member being adjacent to and coupled with the top portion.

5. A cell as set forth in claim 4, wherein the third portion of the first horizontal member does not extend between the third corner column and the forth corner column.

6. A cell as set forth in claim 2, wherein the cell includes a top portion, the second horizontal member is adjacent to and coupled with the top portion, the first horizontal member is substantially circular and extends between all of the plurality of the corner columns, and the second horizontal member is substantially circular and extends between all of the plurality of corner columns.

7. A cell as set forth in claim 2, wherein the cell includes a top portion, the second horizontal member is adjacent to and coupled with the top portion, the second horizontal member is substantially circular and extends between all of the plurality of corner columns, and wherein the first horizontal member extends between the first of the corner columns and a third of the corner columns, between the first of the corner columns and the second of the corner columns, and between the second of the corner columns and a fourth of the corner columns.

8. A cell as set forth in claim 7, wherein first horizontal member does not extend between the third of the corner columns and the fourth of the corner columns.

9. A cell as set forth in claim 2 further comprising a second side wall, the second side wall extending from the second of the corner columns to a third of the corner columns, the second side wall further extending from the first horizontal member to the second horizontal member.

10. A cell as set forth in claim 9, wherein the cell includes a top portion, wherein the second horizontal member is adjacent to and coupled with the top portion, and wherein the second horizontal member is substantially arcuate and extends between the third of the corner columns and a fourth of the corner columns and extends between the fourth of the corner columns and the first of the corner columns.

11. A cell as set forth in claim 10, wherein the first horizontal member is substantially arcuate and extends between the third of the corner columns and the fourth of the corner columns and extends between the fourth of the corner columns and the first of the corner columns.

12. A cell as set forth in claim 10, wherein the first horizontal member extends between the fourth of the corner columns and the first of the corner columns.

13. A cell as set forth in claim 10, wherein a first pair of corner columns comprises the fourth of the corner columns and the third of the corner columns, a second pair of corner columns comprises the fourth of the corner columns and the first of the corner columns, and wherein the first horizontal member does not extend between one or more of the first pair of corner columns and the second pair of corner columns.

14. A cell as set forth in claim 1, wherein the cell includes a top portion, the second horizontal member is adjacent to and coupled with the top portion, the first horizontal member is substantially circular and extends between all of the plurality of the corner columns, and the second horizontal member is substantially circular and extends between all of the plurality of corner columns.

15. A cell as set forth in claim 1, wherein the first horizontal member does not extend between a first and a second corner column and does not extend a between a third and a fourth corner column.

16. A cell as set forth in claim 1, wherein the plurality of corner columns includes four corner columns positioned in a rectangular configuration, each one of the four corner columns at a different corner.

17. A cell as set forth in claim 1 further comprising a plurality of threaded fasteners at least partially embedded in the body portion, the threaded fasteners adapted and configured to be inserted into a plate included in a second cell and to attach the cell to the second cell.

18. A cell as set forth in claim 1 further comprising a gasket extending along at least the perimeter of the at least one of a top portion or a bottom portion.

19. A cell as set forth in claim 1, wherein the body portion is a single monolithic support adapted and configured to support the top portion, and wherein the single monolithic support includes a plurality of windows, each window of the plurality of windows extending between a pair of adjacent corner columns of the plurality of corner columns.

20. A cell as set forth in claim 1, wherein the body portion is substantially cylindrical, and wherein the top portion is cantilevered relative to the body portion such that the top portion extends radially outward from substantially an entire circumference of the body portion.

21. A stormwater management system comprising:
a first cell comprising a body portion, an internal region, a top portion, and a plate, the body portion comprising a plurality of corner columns spaced from each other and extending from the top portion, a first horizontal member, and a second horizontal member, the first horizontal member extending between at least two corner columns and having at least a portion curved inward towards the internal region, the second horizontal member extending between at least two corner columns and having at least a portion curved inward towards the internal region, the plate coupled, by a plurality of anchors, to the body portion opposite the top portion, the plate including a plurality of through holes arranged in a bolt pattern; and
a second cell comprising a body portion, an internal region, a bottom portion, and a plurality of threaded anchors, the body portion comprising a plurality of corner columns spaced from each other and extending from the bottom portion, a first horizontal member, and a second horizontal member, the first horizontal member extending between at least two corner columns and having at least a portion curved inward towards the internal region, the second horizontal member extending between at least two corner columns and having at least a portion curved inward towards the internal region, the plurality of threaded anchors coupled to the body portion opposite the bottom portion, each of the plurality of threaded anchors adapted and configured to receive a nut with an outer diameter larger than that of the through holes, the plurality of threaded anchors positioned to correspond to the bolt pattern.

22. A stormwater management system comprising:
a first cell comprising a body portion, an internal region, a top portion, and a gasket, the body portion comprising a plurality of corner columns spaced from each other and extending from the top portion, a first horizontal member, and a second horizontal member, the first horizontal member extending between at least two corner columns and having at least a portion curved inward towards the internal region, the second horizontal member extending between at least two corner columns and having at least a portion curved inward towards the internal region, the gasket extending along at least a portion of the perimeter of the top portion; and
a second cell comprising a body portion, an internal region, a top portion, and a gasket, the body portion comprising a plurality of corner columns spaced from each other and extending from the bottom portion, a first horizontal member, and a second horizontal member, the first horizontal member extending between at least two corner columns and having at least a portion curved inward towards the internal region, the second horizontal member extending between at least two corner columns and having at least a portion curved inward towards the internal region, the gasket extending along at least a portion of the perimeter of the top portion;
wherein the first cell and the second cell are adapted and configured to be placed in the stormwater management system such that a segment of the top portion of the first cell is parallel and adjacent a corresponding segment of the top portion of the second cell, and wherein the gasket of the first cell and the gasket of the second cell form a substantially watertight seal between the segment of the top portion of the first cell and the corresponding segment of the top portion of the second cell when the first and second cells are placed in the stormwater management system.
